(19) United States
(12) Patent Application Publication
(10) Pub. No.: US 2011/0088006 A1
(43) Pub. Date: Apr. 14, 2011

(54) METHOD FOR LAYOUT VERIFICATION OF SEMICONDUCTOR INTEGRATED CIRCUIT

(75) Inventors: Seijiro KOJIMA, Kyoto (JP); Masaomi TOYAMA, Osaka (JP); Tsutomu YOSHIDOME, Hyogo (JP); Masanori ITO, Osaka (JP)

(73) Assignee: PANASONIC CORPORATION, Osaka (JP)

(21) Appl. No.: 12/970,499

(22) Filed: Dec. 16, 2010

Related U.S. Application Data
(63) Continuation of application No. PCT/JP2010/000994, filed on Feb. 17, 2010.

(30) Foreign Application Priority Data
Apr. 24, 2009 (JP) 2009-106422

(51) Int. Cl. G06F 17/50

(52) U.S. Cl. 716/112

(57) ABSTRACT

A method for verifying a match between layout patterns of elements provided in a semiconductor integrated circuit, includes a verification condition setting step of setting a verification condition including information about paired elements whose layout patterns should match each other, a layout data input step of inputting layout data including pattern information and arrangement information of the paired elements, and a mismatched pattern parameter calculation layout verifying step of comparing the layout patterns of the paired elements based on the verification condition and the layout data to calculate a distance between the paired elements and at least one mismatched pattern.

### CROSS-REFERENCE TO RELATED APPLICATIONS

This is a continuation of PCT International Application PCT/JP2010/000994 filed on Feb. 17, 2010, which claims priority to Japanese Patent Application No. 2009-106422 filed on Apr. 24, 2009. The disclosures of these applications including the specifications, the drawings, and the claims are hereby incorporated by reference in their entirety.

### BACKGROUND

The present disclosure relates to methods for verifying the layouts of semiconductor integrated circuits, and more particularly, to layout verification methods for verifying whether or not layout patterns match.

In recent years, design rules have been reduced to increase the integration densities of semiconductor integrated circuits (LSIs). The reduction of design rules has increased the relative ratio of the sizes of minute elements fabricated in LSIs and manufacture variations during fabrication processes of semiconductor integrated circuits, and at present, variations in circuit characteristics are becoming problematic.

To address such a problem, a plurality of elements may be provided in pairs in the layout design of semiconductor integrated circuits. The paring arrangement means that elements having the same shape or pattern are placed close to each other so that the elements are equally affected by surrounding elements or patterns. As a result, elements having high relative accuracy can be formed.

For example, differential circuits or current mirror circuits need to include a plurality of transistors having the same characteristics, and therefore, the symmetry of shapes, characteristics, and variations on a silicon wafer as well as the symmetry of the circuit is a key factor. Therefore, during a layout design stage, the transistors are arranged in pairs, and a mask layout is designed, taking into consideration the shape of each pair of two elements (paired elements) and the relationship between the paired elements and a surrounding pattern.

FIG. 28 shows a method for verifying whether or not the layout of paired elements included in a differential circuit or a current mirror circuit are properly designed, taking into consideration the shape and arrangement of the paired elements, and the relationship between the paired elements and a surrounding pattern.

FIG. 28 is a flowchart of an example conventional layout verification method (layout verification step 1). The method includes setting or inputting a verification condition 100 and layout data 200 including information about paired elements to be verified, etc. Specifically, the method includes a verification condition setting step 10, a layout data input step 20, a coordinate system changing step 30, and a pattern comparing step 40 for each layer, which are performed to output comparison region difference information 300 indicating a mismatched pattern. The method also includes a mismatched pattern display step 50 of displaying the mismatched pattern.

Each step will be described hereinafter with reference to FIG. 28. The verification condition setting step 10 includes setting the verification condition 100 including paired element setting information 110 for setting paired elements which are to be verified, paired element arrangement information 120 for setting an arrangement (rotation, reversal, etc.) of the paired elements, verification region setting information 130 for setting a region which is to be subjected to verification, layer setting information 140 for setting a layer which is to be subjected to pattern comparison, etc.

The layout data input step 20 includes reading the layout data 200 of a semiconductor integrated circuit including paired elements to be subjected to layout verification, and extracting a layout pattern to be used as a reference (hereinafter referred to as a reference layout pattern or a reference pattern) and a layout pattern to be compared (hereinafter referred to as a comparison layout pattern or a comparison pattern), which are used when paired elements are formed based on the verification condition 100. Here, the extraction of layout patterns, i.e., a reference pattern and a comparison pattern, will be specifically described with reference to FIGS. 29-33.

—Paired Element Setting Information—

FIG. 29 is a diagram showing an example of the verification condition setting step 10 based on the paired element setting information 110 of the verification condition 100, where the layout data 200 includes elements M1-M4. Note that the paired element setting information 110 is used to set desired elements in the layout data 200 which are to be subjected to pattern comparison/verification, and distinguish a reference pattern from a comparison pattern for the convenience of pattern comparison/verification.

For example, it is assumed that the elements M1 and M2 are paired elements, and high relative accuracy is required for characteristics of the elements M1 and M2. In this case, the paired element setting information 110 includes the following settings: the reference pattern=M1; the comparison pattern=M2; the coordinate information of the reference pattern (element M1)=(X_m1, Y_m1); and the coordinate information of the comparison pattern (element M2)=(X_m2, Y_m2). This paired element setting information 110 is set as the verification condition 100 in the verification condition setting step 10. Alternatively, it is assumed that the elements M1 and M3 are paired elements. In this case, the paired element setting information 110 includes the following settings: the reference pattern=M1, the comparison pattern=M3, the coordinate information of the reference pattern (element M1)=(X_m1, Y_m1), and the coordinate information of the comparison pattern (element M3)=(X_m3, Y_m3). This paired element setting information 110 is set as the verification condition 100 in the verification condition setting step 10.

In the above example, paired elements are sets based on the coordinate information of the elements. Alternatively, paired elements may be set using a special layer for recognizing the pairing of the elements, or using instance names in circuit diagram information if the layout data is compatible with the circuit diagram information.

In the above example, paired elements are a one-to-one pairing for the sake of simplicity. Alternatively, a group of the elements M1 and M2 may be set as a reference pattern, while a group of the elements M3 and M4 may be set as a comparison pattern.

—Paired Element Arrangement Information—

FIG. 30 is a diagram of an example of the verification condition setting step 10 based on the paired element arrangement information 120 of the verification condition 100. Note that the paired element arrangement information 120 is used to set an arrangement of desired elements in the layout data 200 which are to be subjected to pattern comparison/verification. For example, when the elements M1 and M2 are paired elements, the paired element arrangement information 120 includes the following settings: the position of the element M1=R0; and the position of the element M2=R0. This paired element arrangement information 120 is set as the verification condition 100 in the verification condition setting step 10. Alternatively, when the elements M1 and M3 are paired elements, the paired element arrangement information 120 includes the following settings: the position of the element M1=R0; and the position of the element M3=R180. This paired element arrangement information 120 is set as the verification condition 100 in the verification condition setting step 10.

Here, the position settings of paired elements are denoted as R0 and R180. In the paired element setting information 110, the position setting means a rotational angle or a reversed position as measured with reference to the position of an element which is a reference pattern. The reference position is indicated by R0, and the position of a pattern rotated counterclockwise by 180 degrees is indicated by R180. Moreover, a pattern which is laterally reversed with reference to the reference position R0 may be indicated by M0 (not shown), and a pattern which is obtained by rotating that pattern counterclockwise by 180 degrees may be indicated by M180 (not shown).

In the above description, the paired element arrangement information 120 is assumed to be previously known. If the paired element arrangement information 120 is not previously known, a desired position to be subjected to pattern comparison/verification can be set as the position of a comparison pattern with reference to the position of a reference pattern (reference).

—Verification Region Setting Information—

FIG. 31 is a diagram of an example of the verification condition setting step 10 based on the verification region setting information 130 of the verification condition 100. Note that the verification region setting information 130 is used to set a desired region in the layout data 200 which is to be subjected to pattern comparison/verification. For example, the verification region setting information 130 includes the following setting: the desired verification region to be subjected to pattern comparison/verification=X (μm). This verification region setting information 130 is set as the verification condition 100 in the verification condition setting step 10.

Note that the verification region setting information 130 is a setting common to paired elements to be subjected to pattern comparison/verification. Alternatively, different desired verification regions may be set for different respective layers to be subjected to pattern comparison/verification.

—Layer Setting Information—

FIG. 32 is a diagram of an example of the verification condition setting step 10 based on the layer setting information 140 of the verification condition 100. Note that the layer setting information 140 is used to set a desired layer in the layout data 200 which is to be subjected to pattern comparison/verification. For example, the layer setting information 140 includes the following setting: the desired verification target layers to be subjected to pattern comparison/verification=a layer in which paired elements are formed, a first interconnection layer, and a second interconnection layer. This layer setting information 140 is set as the verification condition 100 in the verification condition setting step 10.

Note that the layer setting information 140 may include a desired layer(s) to be excluded from pattern comparison/verification, of all layers included in the layout data 200.

By performing the verification condition setting step 10 of setting the verification condition 100 and the layout data input step 20 of inputting the layout data 200 as described above, when, for example, the elements M1 and M2 are paired elements, a pattern to be subjected to pattern comparison/verification is extracted as shown in FIG. 33.

Next, in the coordinate system changing step 30, reference coordinates are changed (reference coordinate matching) so that a reference pattern and a comparison pattern for formation of paired elements can be compared with each other, and in-comparison-region pattern data 600 of a reference pattern element and in-comparison-region pattern data 700 of a comparison pattern element are generated for each layer to be subjected to pattern comparison based on the verification condition 100.

Next, in the pattern comparing step 40, for each layer, the pattern data 600 and 700 are input and subjected to pattern comparison by an exclusive OR (EOR) operation to determine whether there is a match or a mismatch between the pattern data 600 and 700. Here, an example of the pattern comparing step 40 will be briefly described.

Portions (a) and (b) of FIG. 34 show cases where the elements M1 and M2 are paired elements, and the EOR operation is performed with respect to the element M1 as a reference pattern and the element M2 as a comparison pattern. In the portion (a) of FIG. 34, the patterns of the elements M1 and M2 match in a verification region (there is no pattern comparison difference), and therefore, as a result of the EOR operation, a mismatched pattern (a difference between the patterns) is not output. On the other hand, in the portion (b) of FIG. 34, the patterns of the elements M1 and M2 do not match in the verification region (there is a pattern comparison difference), and therefore, as a result of the EOR operation, the comparison region difference information 300 of each layer (a mismatched pattern E1 as a pattern comparison difference of the first interconnection layer, and mismatched patterns E2-E4 as pattern comparison differences of the second interconnection layer) is output. In the mismatched pattern display step 50, the comparison region difference information 300 is displayed as mismatched patterns.

FIG. 35 shows a case where the elements M1 and M3 are paired elements, and the EOR operation is performed with respect to the element M1 as a reference pattern and the element M3 as a comparison pattern. Note that, for the element M3, the pattern of the element M3 is rotated clockwise by 180 degrees from the position=R180 thereof previously set in the paired element arrangement information 120, and thereafter, the EOR operation is performed with respect to the resultant pattern as a comparison pattern. In this case, the elements M1 and M3 do not match in the verification region. Therefore, as a result of the EOR operation, the comparison region difference information 300 of each layer (a mismatched pattern E5 as a pattern comparison difference in the first interconnection layer, and mismatched patterns E6-E8 as pattern comparison differences in the second interconnection layer) are output. In the mismatched pattern display step 50, the comparison region difference information 300 is displayed as mismatched patterns.

In the pattern comparing step 40, pattern comparison is repeatedly performed with respect to all layers on a layer-by-layer basis. When pattern comparison is completed with respect to all the layers, the layout verification is completed.

A more specific example of the above conventional layout verification method is described in, for example, Japanese Patent Publication No. 2007-265179.

In the layout verification method, a verification region is set for a plurality of elements which are arranged in pairs, an interconnection pattern, etc. is extracted from the set verification region, and it is verified whether or not the extracted patterns of the elements for which pairing arrangement is to be verified have the same shape.

### SUMMARY

In the conventional layout verification method of FIG. 28 and the layout verification method of Japanese Patent Publication No. 2007-265179, it can be detected whether there is a match or a mismatch in a pattern/shape in the verification region set for pattern comparison between paired elements arranged in a pair and their surrounding patterns, but any method for addressing the case where there is a mismatched pattern is not suggested or taught. When there is a mismatched pattern, then if the layout is modified so that a match is established in all layout patterns in the set verification region, the number of repetitions of the modification step is likely to increase.

The present disclosure describes implementations of a semiconductor integrated circuit layout verification method capable of reducing the number of repetitions of the layout modification step for a semiconductor integrated circuit having paired elements.

An example method for verifying a match between layout patterns of elements provided in a semiconductor integrated circuit, includes a verification condition setting step of setting a verification condition including information about paired elements whose layout patterns should match each other, a layout data input step of inputting layout data including pattern information and arrangement information of the paired elements, and a mismatched pattern parameter calculation layout verifying step of comparing the layout patterns of the paired elements based on the verification condition and the layout data to calculate a distance between the paired elements and at least one mismatched pattern.

Specifically, the mismatched pattern parameter calculation layout verifying step includes a mismatched pattern obtaining step of verifying a match/mismatch between the layout patterns of the paired elements and between layout patterns of regions surrounding the paired elements based on the verification condition and the layout data, a mismatched pattern determining step of determining which of the surrounding regions of the paired elements contains the at least one mismatched pattern between the layout patterns obtained in the mismatched pattern obtaining step, and a mismatch distance calculating step of calculating a distance between the paired elements and the at least one mismatched pattern between the layout patterns obtained in the mismatched pattern obtaining step.

Another example method for verifying a match between layout patterns of elements provided in a semiconductor integrated circuit, includes a verification condition setting step of setting a verification condition including information about paired elements whose layout patterns should match each other, a layout data input step of inputting layout data including pattern information and arrangement information of the paired elements, and a mismatched pattern parameter calculation layout verifying step of comparing the layout patterns of the paired elements based on the verification condition and the layout data to calculate a distance between the paired elements and at least one mismatched pattern, and an area of the at least one mismatched pattern.

Specifically, the mismatched pattern parameter calculation layout verifying step includes a mismatched pattern obtaining step of verifying a match/mismatch between the layout patterns of the paired elements and between layout patterns of regions surrounding the paired elements based on the verification condition and the layout data, a mismatched pattern determining step of determining which of the surrounding regions of the paired elements contains the at least one mismatched pattern between the layout patterns obtained in the mismatched pattern obtaining step, a mismatch distance calculating step of calculating a distance between the paired elements and the at least one mismatched pattern between the layout patterns obtained in the mismatched pattern obtaining step, and a mismatch area calculating step of calculating an area of the at least one mismatched pattern between the layout patterns obtained in the mismatched pattern obtaining step.

Specifically, in the verification condition setting step, the verification condition for verifying a match between the layout patterns includes mismatch distance calculation information. The mismatched pattern parameter calculation layout verifying step sets, as a mismatch distance, a distance between the paired elements and the at least one mismatched pattern, where a shortest one of the longer ones of X-axis direction Manhattan distances and Y-axis direction Manhattan distances between vertices on a layout pattern of the paired elements and vertices on a layout pattern of the at least one mismatched pattern, is defined as the distance between the paired elements and the at least one mismatched pattern, based on the verification condition setting including the mismatch distance calculation information.

Alternatively, in the verification condition setting step, the verification condition for verifying a match between the layout patterns includes mismatch distance calculation information. The mismatched pattern parameter calculation layout verifying step sets, as a mismatch distance, a distance between the paired elements and the at least one mismatched pattern, where a straight-line and shortest one of distances between vertices or edges on a layout pattern of the paired elements and vertices or edges on a layout pattern of the at least one mismatched pattern, is defined as the distance between the paired elements and the at least one mismatched pattern, based on the verification condition setting including the mismatch distance calculation information.

Alternatively, in the verification condition setting step, the verification condition for verifying a match between the layout patterns includes mismatch distance calculation information. The mismatched pattern parameter calculation layout verifying step calculates a mismatch distance between the paired elements and each of the at least one mismatched pattern, based on the verification condition setting including the mismatch distance calculation information.

Alternatively, in the verification condition setting step, the verification condition for verifying a match between the layout patterns includes mismatch distance calculation information. The mismatched pattern parameter calculation layout verifying step calculates a shortest one of mismatch distances between the paired elements and a target one or ones of the at least one mismatched pattern, based on the verification condition setting including the mismatch distance calculation information.

Alternatively, in the verification condition setting step, the verification condition for verifying a match between the layout patterns includes mismatch distance calculation information and mismatch area calculation information. The mismatched pattern parameter calculation layout verifying step calculates a distance between the paired elements and the at least one mismatched pattern, and an area of the at least one mismatched pattern, based on the verification condition setting including the mismatch distance calculation information and the mismatch area calculation information.

Alternatively, in the verification condition setting step, the verification condition for verifying a match between the layout patterns includes mismatch distance calculation information, mismatch area calculation information, and verification acceptable error information. The mismatched pattern parameter calculation layout verifying step verifies a perfect match or a match within an acceptable range between the layout patterns of the paired elements and between layout patterns of regions surrounding the paired elements, and calculates a distance between the paired elements and the at least one mismatched pattern, and an area of the at least one mismatched pattern, based on the verification condition setting including the mismatch distance calculation information, the mismatch area calculation information, and the verification acceptable error information.

The above example method further includes a characteristic influence calculating step of calculating a characteristic influence on the paired elements based on a relationship between characteristic influences on elements and one of the mismatch distance and the mismatch area calculated in the mismatched pattern parameter calculation layout verifying step, and a position of the at least one mismatched pattern, or a combination thereof, and a characteristic influence verifying step of verifying whether or not the calculated characteristic influence is acceptable for formation of the paired elements.

### BRIEF DESCRIPTION OF THE DRAWINGS

FIG. 1 is a flowchart of layout verification according to an embodiment of the present disclosure.

FIG. 2 is a flowchart of a mismatched pattern parameter calculation layout verifying step.

FIG. 3 is a flowchart showing an internal process of a mismatched pattern determining step.

FIG. 4 is a diagram for describing example process details of the mismatched pattern determining step.

FIG. 5 is a flowchart showing an internal process of a mismatch distance calculating step.

FIG. 6 is a diagram schematically showing a case where a mismatched pattern is present in a verification region.

FIG. 7 is a diagram showing a transistor gate, edges, a verification range, and a verification region of an element.

FIG. 8 is a diagram showing division of a verification region.

FIG. 9 is a diagram showing a result of cutting and separation of a mismatched pattern.

FIG. 10 is a diagram showing example calculation of a mismatch distance of a cut/separated mismatched pattern.

FIG. 11 is a diagram showing another example calculation of a mismatch distance of a cut/separated mismatched pattern.

FIG. 12 is a diagram for describing a method for calculating a mismatch distance.

FIG. 13 is a diagram showing still another example calculation of a mismatch distance of a cut/separated mismatched pattern.

FIG. 14 is a diagram for describing another method for calculating a mismatch distance.

FIG. 15 is a diagram showing information about a distance to a mismatched pattern.

FIG. 16 is a diagram showing another example calculation of a mismatch distance of a cut/separated mismatched pattern.

FIG. 17 is a diagram showing still another example calculation of a mismatch distance in a cut/separated mismatched pattern.

FIG. 18 is a flowchart of a verification flow in a layout verification method including a mismatch area calculating step.

FIG. 19 is a flowchart showing an internal process of a mismatch distance calculating step/mismatch area calculating step.

FIG. 20 is a flowchart showing a verification flow in a layout verification method including an area determining step.

FIG. 21 is a flowchart showing an internal process of a mismatch distance calculating step/mismatch area calculating step.

FIG. 22 is a diagram for describing acceptable error information.

FIG. 23 is a diagram for describing a specific process in an area determining step.

FIG. 24 is a flowchart showing a verification flow in a second half of the layout verification method.

FIG. 25 is a diagram showing a model of characteristic influence depending on a distance to a mismatched pattern.

FIG. 26 is a diagram showing a model of a characteristic influence per mismatched pattern unit area depending on a distance to a mismatched pattern.

FIG. 27 is a diagram showing example process details of a characteristic influence verifying step.

FIG. 28 is a flowchart showing a verification flow in an example conventional layout verification method.

FIG. 29 is a diagram showing an example verification condition setting step based on paired element setting information.

FIG. 30 is a diagram showing an example verification condition setting step based on paired element arrangement information.

FIG. 31 is a diagram showing an example verification condition setting step based on verification region setting information.

FIG. 32 is a diagram showing an example verification condition setting step based on layer setting information.

FIG. 33 is a diagram showing example extraction of a pattern to be subjected to pattern comparison/verification.

FIG. 34 is a diagram for describing an EOR operation.

FIG. 35 is a diagram for describing an EOR operation.

### DETAILED DESCRIPTION

A layout verification method for a semiconductor integrated circuit according to an embodiment of the present disclosure will be described hereinafter with reference to the accompanying drawings.

<Flow of Layout Verification>

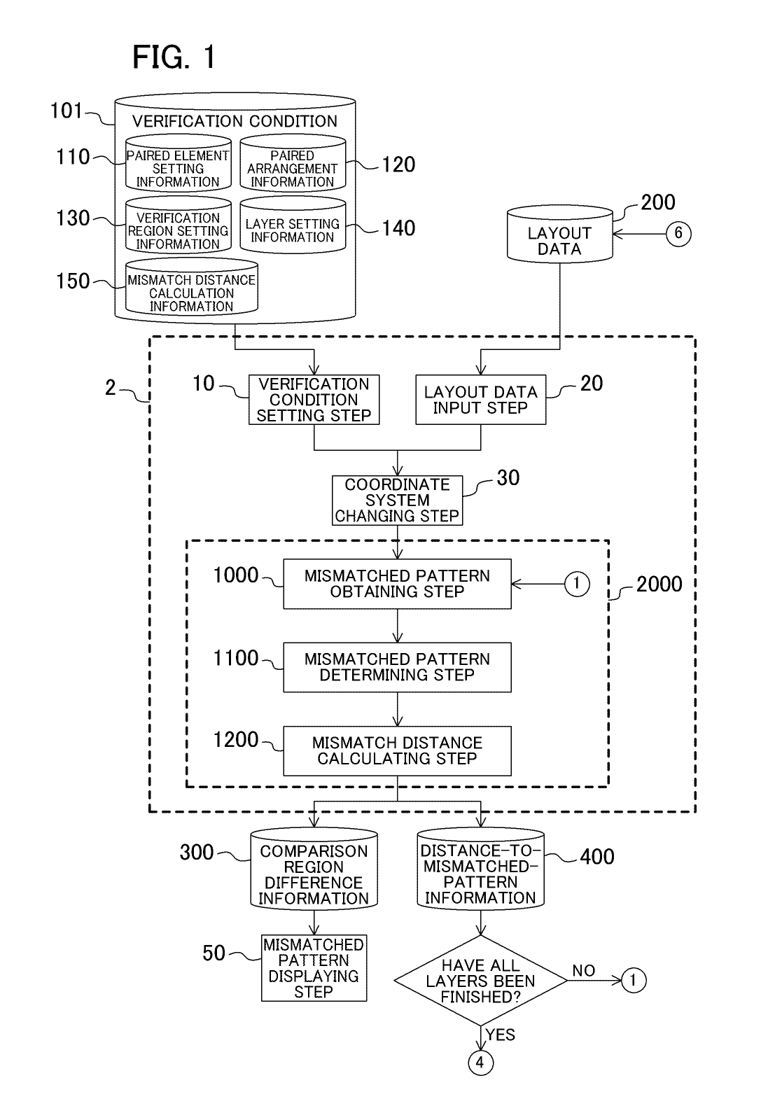

FIG. 1 is a flowchart showing a layout verification step 2 according to an embodiment of the present disclosure. In the verification flow of FIG. 1, a verification condition setting step 10 sets a verification condition 101 which includes one of or a combination of the following pieces of information: paired element setting information 110 for setting two elements (paired elements) which are to be verified; paired element arrangement information 120 for setting an arrangement (rotation, reversal, etc.) of the paired elements; verification region setting information 130 for setting a verification region which has a predetermined range around each of the paired elements; layer setting information 140 for setting a layer which is to be subjected to pattern comparison; and mismatch distance calculation information 150 for calculating a mismatch distance (described below) with respect to a mismatched pattern which is a result of comparison of layout patterns in the verification region. Here, the mismatch distance refers to a distance between an element (verification element) and a mismatched pattern in a verification region where the mismatched pattern is present. Although paired elements are assumed to be a one-to-one pairing, a group of elements may be set as a verification target. Next, the layout data input step 20 reads layout data 200 of the semiconductor integrated circuit including paired elements which is to be subjected to layout verification.

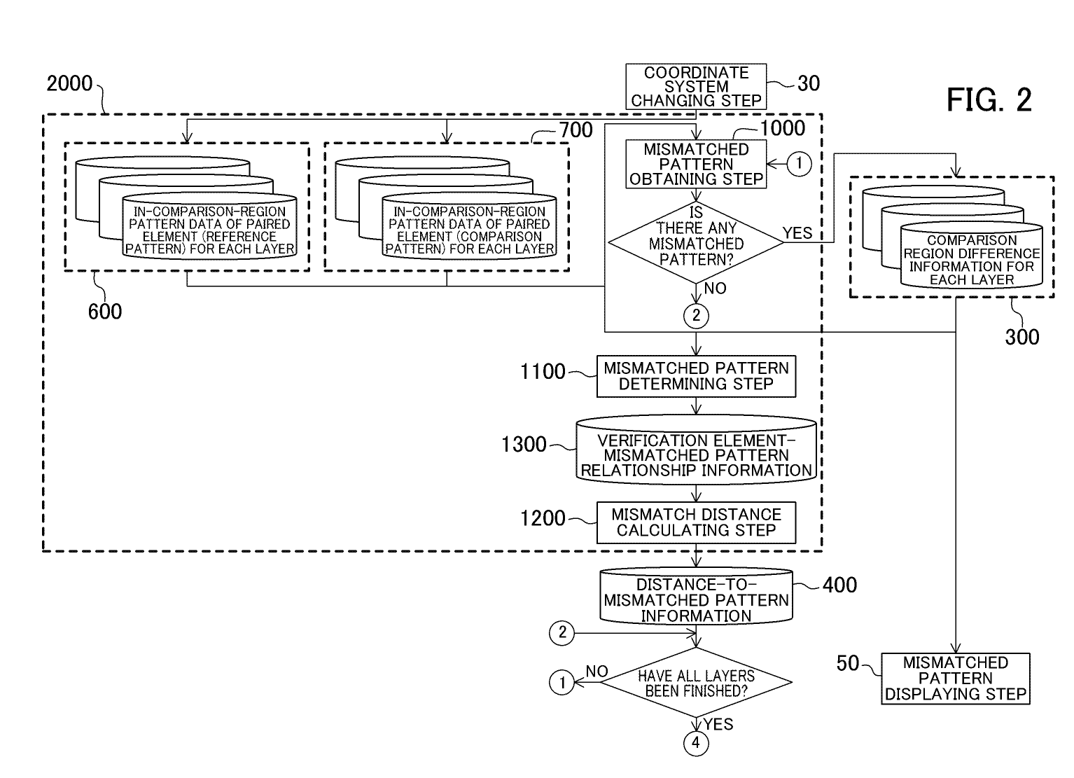

Thereafter, the coordinate system changing step 30 changes reference coordinates with respect to the layout data 200 read in the layout data input step 20 so that pattern comparison can be performed based on the verification condition 101 set in the verification condition setting step 10. Thereafter, based on the result of the coordinate system changing step 30, a mismatched pattern parameter calculation layout verification step 2000 performs layout verification in which the verification regions set for the paired elements are compared, and calculates a mismatch distance, and as a result, obtains comparison region difference information 300 indicating a mismatched pattern in the verification region, and mismatch distance information 400 indicating a distance to the mismatched pattern. The mismatched pattern display step 50 displays the mismatched pattern indicated by the comparison region difference information 300 thus obtained. The mismatch distance information 400 indicating the distance to the mismatched pattern is used in the next step. A process flow of the mismatched pattern parameter calculation layout verification step 2000 will be described in greater detail hereinafter with reference to FIG. 2.

—Mismatched Pattern Obtaining Step—

A mismatched pattern obtaining step 1000 compares in-comparison-region pattern data 600 of a reference pattern generated in the coordinate system changing step 30 with in-comparison-region pattern data 700 of a comparison pattern to obtain a mismatched pattern in which the layout patterns do not match in the verification region.

—Mismatched Pattern Determining Step—

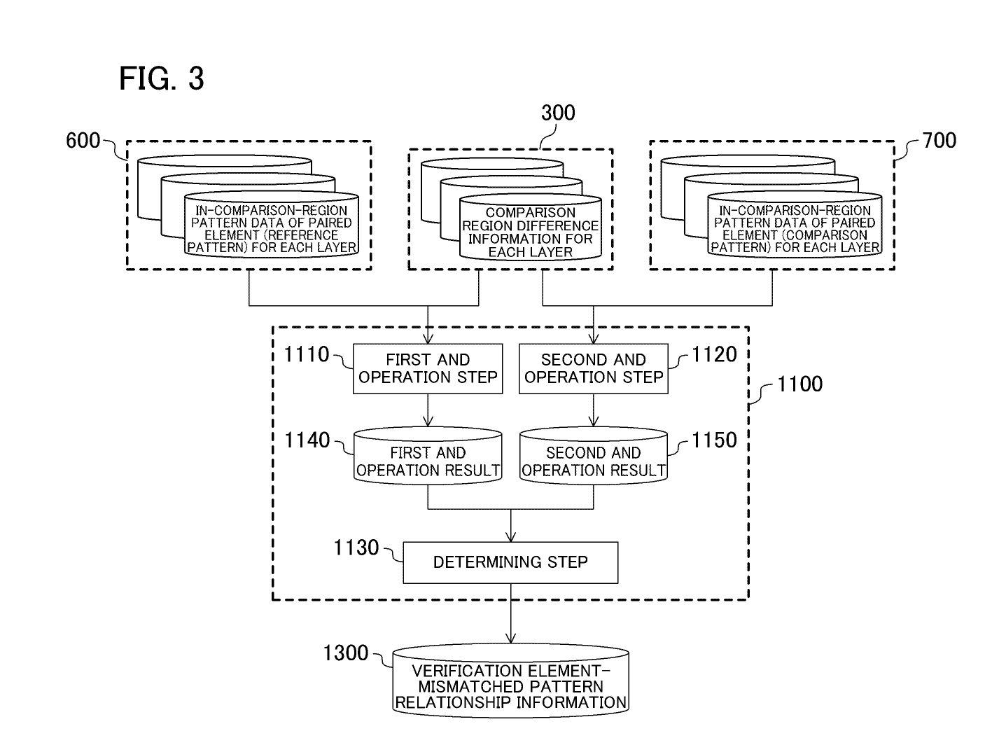

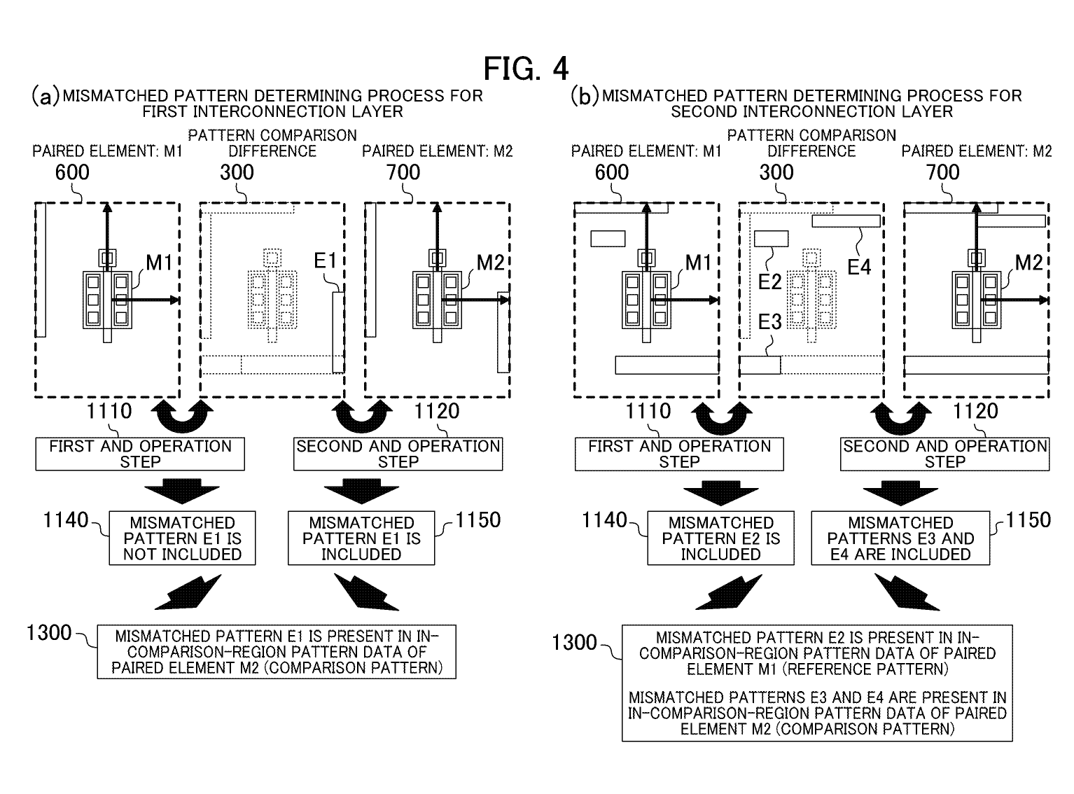

A mismatched pattern determining step 1100 performs determination based on the in-comparison-region pattern data 600 of the reference pattern, the in-comparison-region pattern data 700 of the comparison pattern, and the comparison region difference information 300 which has been generated when there is a mismatch as a result of the mismatched pattern obtaining step 1000, to obtain information 1300 indicating a relationship between the verification element and the mismatched pattern. Here, a specific example process of the mismatched pattern determining step 1100 will be described with reference to FIGS. 3 and 4.

FIG. 3 is a flowchart showing an internal process of the mismatched pattern determining step 1100. FIG. 4 is a diagram for describing example details of the process of FIG. 3. Specifically, a portion (a) of FIG. 4 shows a case where the mismatched pattern determining process is performed with respect to a first interconnection layer, and a portion (b) of FIG. 4 shows a case where the mismatched pattern determining process is performed with respect to a second interconnection layer.

Here, it is assumed that elements M1 and M2 are paired elements. A first AND operation step 1110 performs a first AND operation with respect to the in-comparison-region pattern data 600 of the element M1 as a reference pattern in the first interconnection layer and the comparison region difference information 300 (a mismatched pattern E1 of the portion (a) of FIG. 4) of the first interconnection layer, to obtain a result indicating that the mismatched pattern E1 is not included in the in-comparison-region pattern data 600 (first AND operation result 1140). On the other hand, a second AND operation step 1120 performs a second AND operation with respect to in-comparison-region pattern data 700 of the element M2 as a comparison pattern in the first interconnection layer and the comparison region difference information 300 (the mismatched pattern E1 of the portion (a) of FIG. 4) of the first interconnection layer, to obtain a result indicating that the mismatched pattern E1 is included in the in-comparison-region pattern data 700 (second AND operation result 1150).

Next, a determining step 1130 performs determination based on the first AND operation result 1140 and the second AND operation result 1150 to obtain the verification element-mismatched pattern relationship information 1300 which is information about the element M2 and the mismatched pattern, indicating that the mismatched pattern El is present as a verification element in the in-comparison-region pattern data of the element M2.

Similarly, the first AND operation step 1110 performs the first AND operation with respect to the in-comparison-region pattern data 600 of the element M1 in the second interconnection layer and the comparison region difference information 300 (mismatched patterns E2-E4 of the portion (b) of FIG. 4) of the second interconnection layer, to obtain a result indicating that the mismatched pattern E2 is included in the in-comparison-region pattern data 600 (first AND operation result 1140). On the other hand, the second AND operation step 1120 performs the second AND operation with respect to the in-comparison-region pattern data 700 of the element M2 in the second interconnection layer, and the comparison region difference information 300 (the mismatched patterns E2-E4 of the portion (b) of FIG. 4) of the second interconnection layer, to obtain a result indicating that the mismatched patterns E3 and E4 are included in the in-comparison-region pattern data 700 (second AND operation result 1150).

Next, the determining step 1130 performs determination based on the first AND operation result 1140 and the second AND operation result 1150 to obtain the verification element-mismatched pattern relationship information 1300 which is information about the element M2 and the mismatched pattern, indicating that the mismatched pattern E2 is present as a verification element in the in-comparison-region pattern data of the element M1, and the mismatched patterns E3 and E4 are present as verification elements in the in-comparison-region pattern data of the element M2.

—Mismatch Distance Calculating Step—

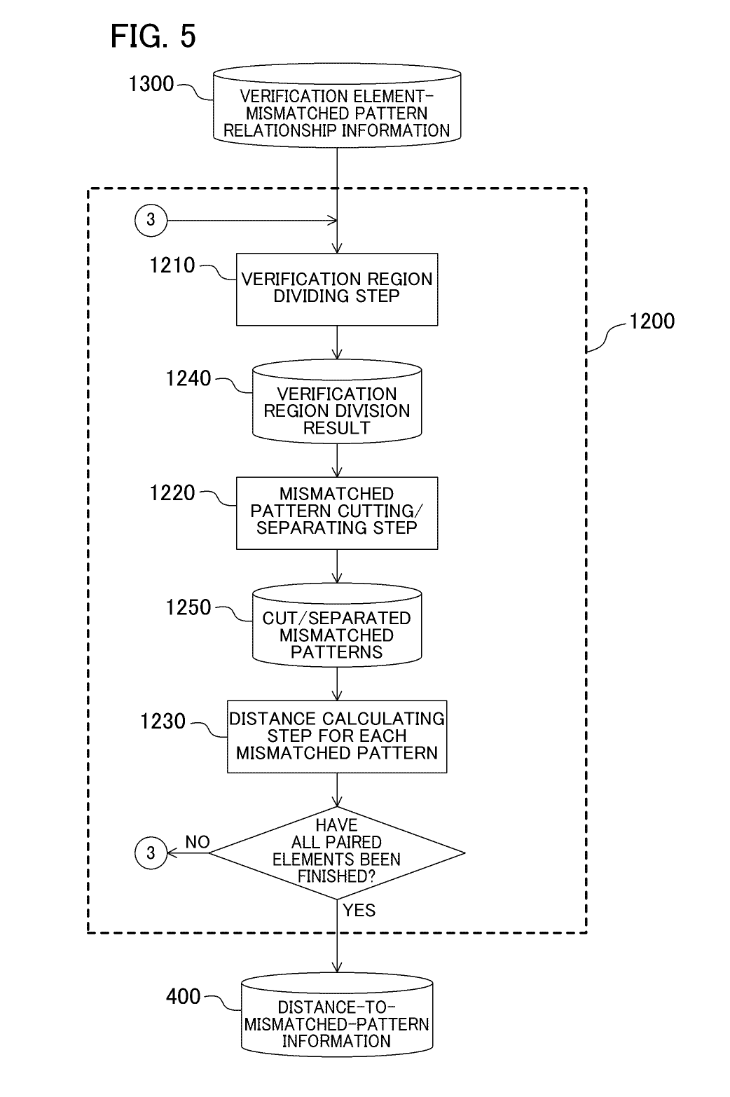

A mismatch distance calculating step 1200 performs calculation based on the verification element-mismatched pattern relationship information 1300 to obtain information 400 indicating a distance to a mismatched pattern. Here, a specific example process of the mismatch distance calculating step 1200 will be described with reference to FIGS. 5-15.

FIG. 5 is a flowchart showing an internal process of the mismatch distance calculating step 1200. Initially, a verification region dividing step 1210 performs division based on the verification element-mismatched pattern relationship information 1300 to obtain a result 1240 of the division of the verification region. Next, a mismatched pattern cutting/separating step 1220 performs cutting/separation based on the verification region division result 1240 to obtain cut/separated mismatched patterns 1250. Next, a mismatched pattern distance calculating step 1230 calculates a distance for each of the cut/separated mismatched patterns 1250. Here, unless the distance calculation has been completed for all paired elements (reference patterns and comparison patterns), control returns to the verification region dividing step and the process is repeated. If the distance calculation has been completed for all paired elements, the mismatch distance calculating step 1200 outputs the distance-to-mismatched pattern information 400 as a result. Note that details of the verification region dividing step 1210, the mismatched pattern cutting/separating step 1220, and the mismatched pattern distance calculating step 1230 will be described below.

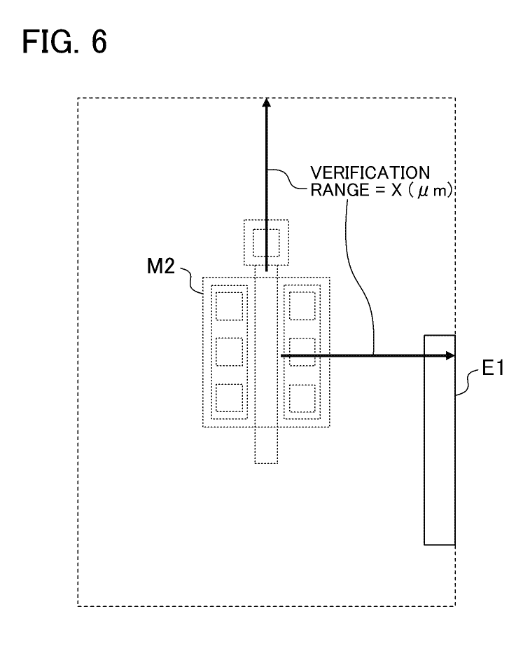

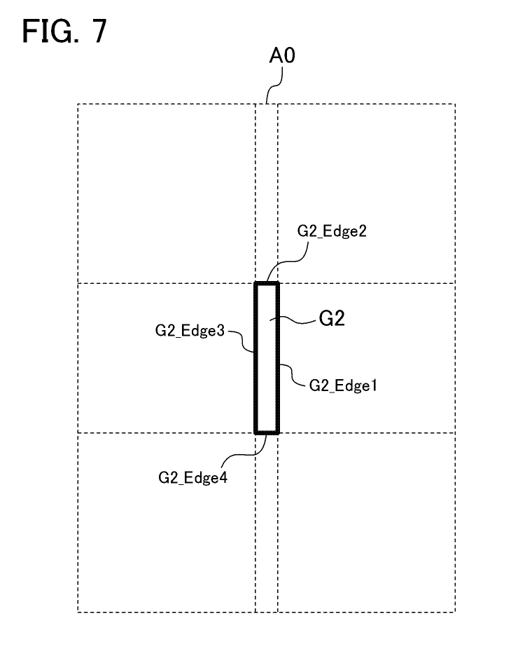

FIG. 6 is diagram schematically showing a case where a mismatched pattern E1 is present in a verification region A0, where the verification element-mismatched pattern relationship information 1300 indicates that the mismatched pattern E1 obtained in the mismatched pattern determining step 1100 is present in the in-comparison-region pattern data of the element M2. FIG. 7 is an enlarged view of a transistor gate G2 (the verification region A0) of the element M2 as a transistor, where the edges of the transistor gate G2 are indicated by G2_Edge1-G2_Edge4, and the verification range=X (μm).

—Verification Region Dividing Step—

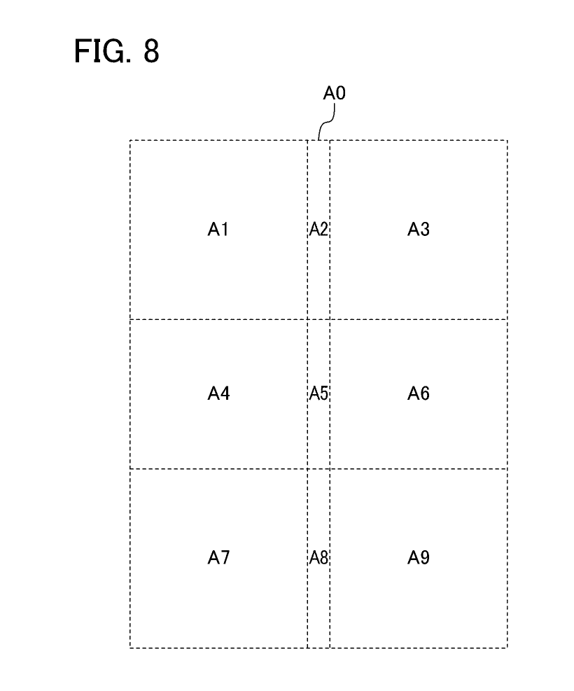

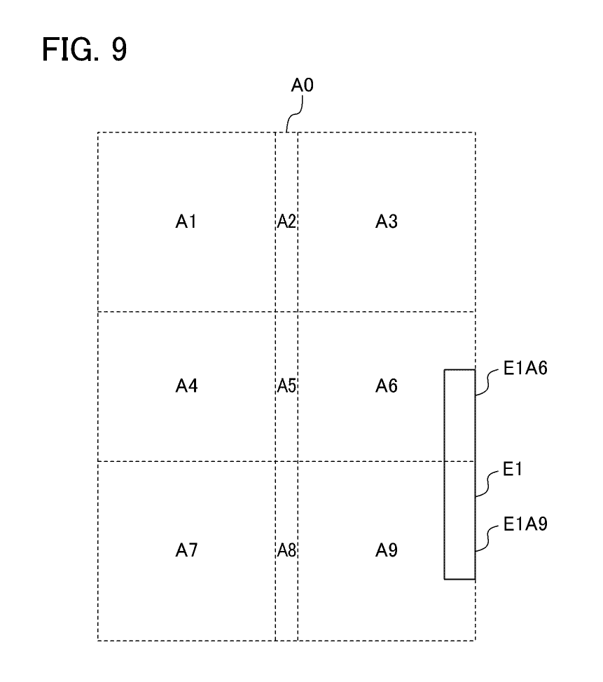

The verification region dividing step 1210 divides the verification region A0. Specifically, a pattern (region) which is obtained by removing the original pattern G2 from a pattern which is obtained by shifting G2_Edge1 of the pattern G2 by the verification range (=X (μm)) in the positive direction of the X-axis, is indicated by A6 in FIG. 8. A pattern (region) which is obtained by removing the original pattern G2 from a pattern which is obtained by shifting G2_Edge4 of the pattern G2 by the verification range (=X (μm)) in the negative direction of the Y-axis, is indicated by A8 in FIG. 8. A pattern (region) which is obtained by removing the original pattern G2, the pattern A6, and the pattern A8 from a pattern which is an outermost periphery of a pattern which is obtained by shifting G2_Edge1 and G2_Edge4 of the pattern G2 by the verification range (=X (μm)) in the positive direction of the X-axis and in the negative direction of the Y-axis, respectively, is indicated by A9 in FIG. 8. As shown in FIG. 9, the verification region A0 is divided into regions A1-A9 by similarly shifting the edges of the pattern G2 and performing a combination of logical calculations, for example.

—Mismatched Pattern Cutting/Separating Step—

The mismatched pattern cutting/separating step 1220 cuts and separates a mismatched pattern based on the verification region divisions A1-A9. FIG. 9 is a diagram schematically showing a result of cutting and separating the mismatched pattern E1. As shown in FIG. 9, the mismatched pattern E1 is cut and separated based on the verification region divisions. The mismatched pattern cutting/separating step 1220 performs an AND operation with respect to the verification region divisions A1-A9 and the mismatched pattern E1 to obtain cut/separated mismatched patterns E1A6 and E1A9.

—Mismatched Pattern Distance Calculating Step—

The mismatched pattern distance calculating step 1230 calculates distances between a verification element and all mismatched patterns and/or the shortest one thereof, based on a

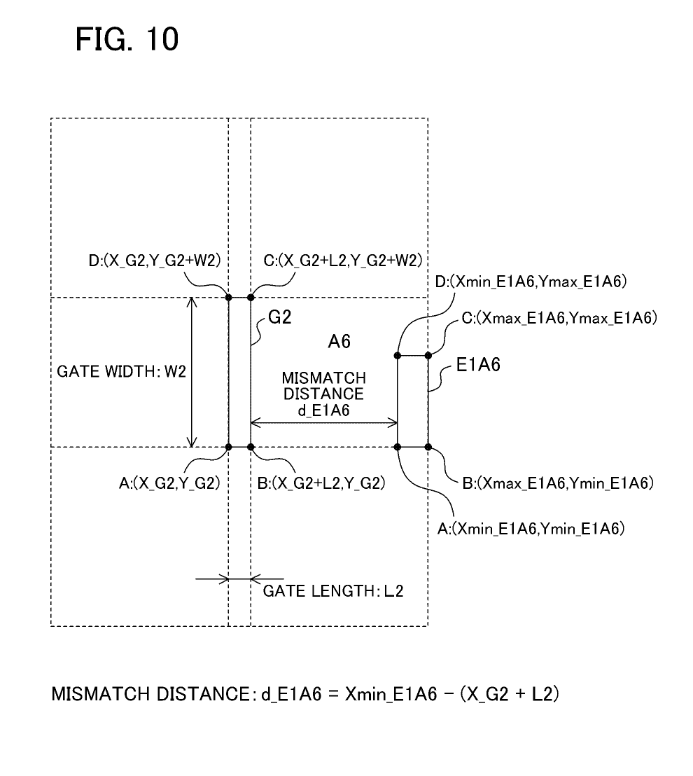

Manhattan distance, a shortest distance along a straight line, etc. FIG. 10 is a diagram showing an example calculation of a mismatch distance d_E1A6 for the cut/separated mismatched pattern E1 A6. In order to calculate the mismatch distance d_E1A6 between the pattern G2 and the cut/separated mismatched pattern E1A6, FIG. 10 shows the following vertex coordinate points of the pattern G2, counterclockwise from the lower left corner of the pattern G2, where L2 indicates the gate length of the pattern G2, and W2 indicates the gate width of the pattern G2: a vertex coordinate point A: (X_G2, Y_G2); a vertex coordinate point B: (X_G2+L2, Y_G2); a vertex coordinate point C: (X_G2+L2, Y_G2+W2): and a vertex coordinate point D: (X_G2, Y_G2+W2). FIG. 10 also shows the following vertex coordinate points of the cut/separated mismatched pattern E1A6, counterclockwise from the lower left corner of the mismatched pattern E1A6: a vertex coordinate point A: (Xmin_E1A6, Ymin_E1A6); a vertex coordinate point B: (Xmax_E1A6, Ymin_E1A6); a vertex coordinate point C: (Xmax_E1A6, Ymax_E1A6); and a vertex coordinate point D: (Xmin_E1A6, Ymax_E1A6). Here, in the verification region division A6, only a distance(s) in the X-axis direction may be taken into consideration, and a mismatch distance may be calculated from the greatest value X_G2+L2 of the X coordinates of the vertex coordinate points of the pattern G2 and the smallest value Xmin_E1A6 of the X coordinates of the vertex coordinate points of the mismatched pattern E1A6. Therefore, the mismatch distance d_E1A6=Xmin_E1A6−(X_G2+L2). Thus, the mismatch distance can be calculated.

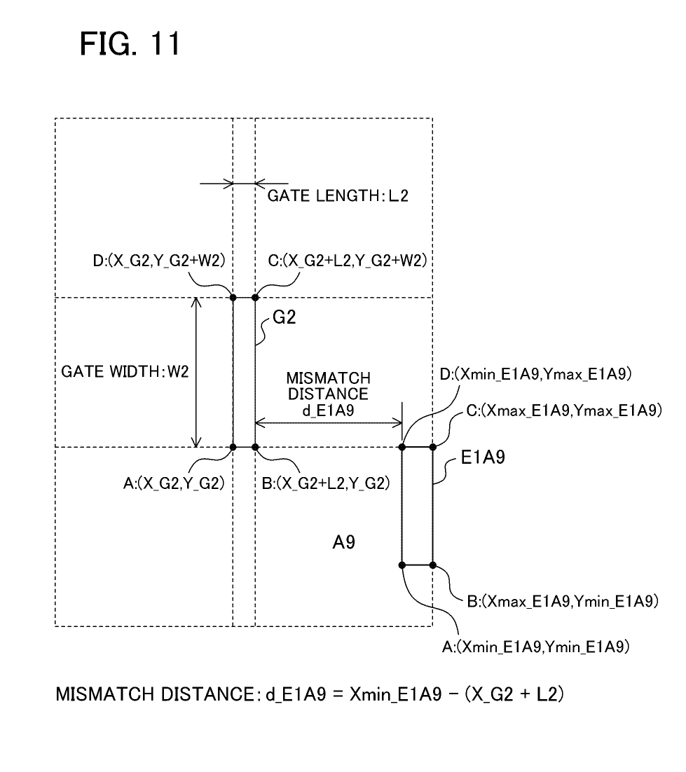

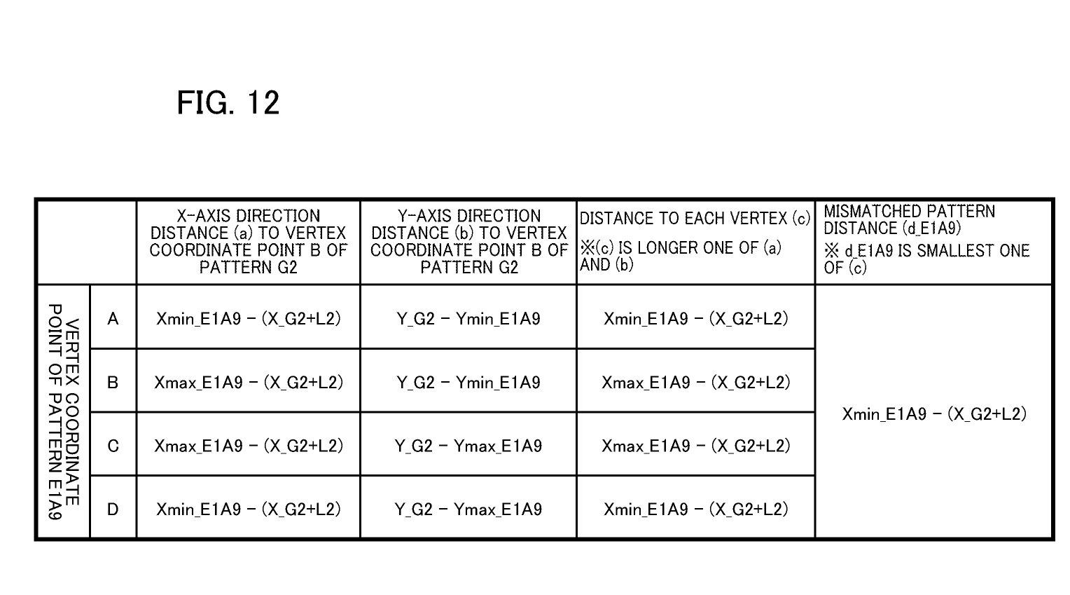

FIG. 11 shows calculation of a mismatch distance d_E1A9 from the pattern G2 for the cut/separated mismatched pattern E1A9. Here, the vertex coordinate points of the pattern G2 are similar to those of FIG. 10. FIG. 11 shows the following vertex coordinate points of the cut/separated mismatched pattern E1A9, counterclockwise from the lower left corner of the mismatched pattern E1A9: a vertex coordinate point A: (Xmin_E1A9, Ymin_E1A9); a vertex coordinate point B: (Xmax_E1A9, Ymin_E1A9); a vertex coordinate point C: (Xmax_E1A9, Ymax_E1A9); and a vertex coordinate point D: (Xmin_E1A9, Ymax_E1A9). In the verification region division A9, distances both in the X-axis direction and the Y-axis direction need to be taken into consideration. In this point, the calculation method in the verification region division A9 is different from that in the verification region division A6. Specifically, distances in the X-axis direction and the Y-axis direction of each vertex of the mismatched pattern E1A9 with reference to the vertex coordinate point B: (X_G2+L2, Y_G2) of the pattern G2 are calculated, and the longer distance is set as the distance of that vertex. The smallest value of the calculated distances of the vertices is set as the mismatch distance d_E1A9 (see FIG. 12). Therefore, in FIG. 11, the mismatch distance d_E1A9=Xmin_E1A9−(X_G2+L2). Thus, the mismatch distance can be calculated.

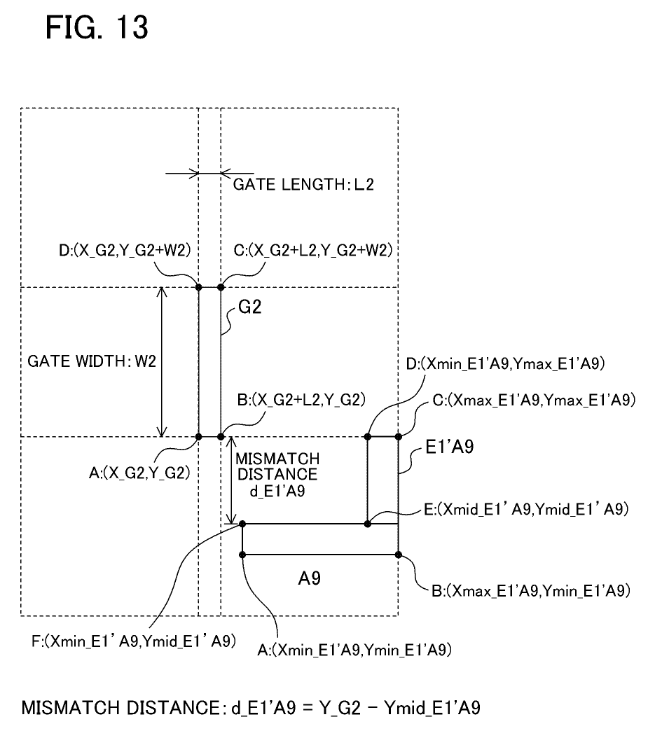

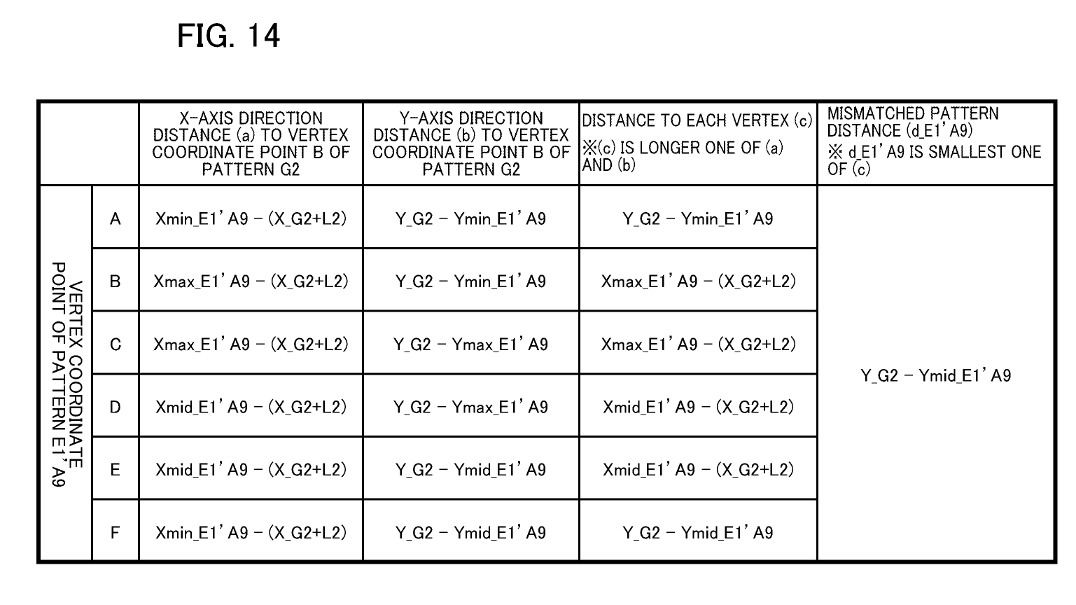

In order to clarify the difference between the calculation method in the verification region division A6 and the calculation method in the verification region division A9, an example of calculation of a mismatch distance d_E1′A9 in the verification region division A9 will be described with reference to FIG. 13. FIG. 13 shows calculation of the mismatch distance d_E1′A9 between the transistor gate G2 and a cut/separated mismatched pattern E1′A9. Here, the vertex coordinate points of the pattern G2 are similar to those of FIG. 10. The cut/separated mismatched pattern E1′A9 has the following vertex coordinate points, counterclockwise from the lower left corner of the mismatched pattern E1′A9: a vertex coordinate point A: (Xmin_E1′A9, Ymin_E1′A9); a vertex coordinate point B: (Xmax_E1′A9, Ymin_E1′A9); a vertex coordinate point C: (Xmax_E1′A9, Ymax_E1′A9); a vertex coordinate point D: (Xmid_E1′A9, Ymax_E1′A9); a vertex coordinate point E: (Xmid_E1′A9, Ymid_E1′A9); and a vertex coordinate point F: (Xmin_E1′A9, Ymid_E1′A9). According to the above calculation method in the verification region division A9, the mismatch distance d_E1′A9=Y_G2−Ymid_E1′A9 is obtained from the result of FIG. 14. In the foregoing, the calculation of the mismatch distances in the verification region divisions A6 and A9 has been described. Mismatch distances in the verification region divisions A2, A4, and A8 may be calculated using a method similar to that used in the verification region division A6, and mismatch distances in the verification region divisions A1, A3, and A7 may be calculated using a method similar to that used in the verification region division A9.

Specifically, in the verification region division A2, only a distance(s) in the Y-axis direction may be taken into consideration, and a mismatch distance may be calculated from the greatest value of the Y coordinates of the vertex coordinate points of the pattern G2 and the smallest value of the Y coordinates of the vertex coordinate points of a cut/separated mismatched pattern of interest.

In the verification region division A4, only a distance(s) in the X-axis direction may be taken into consideration, and a mismatch distance may be calculated from the smallest value of the X coordinates of the vertex coordinate points of the pattern G2 and the greatest value of the X coordinates of the vertex coordinate points of a cut/separated mismatched pattern of interest.

In the verification region division A8, only a distance(s) in the Y-axis direction may be taken into consideration, and a mismatch distance may be calculated from the smallest value of the Y coordinates of the vertex coordinate points of the pattern G2 and the greatest value of the Y coordinates of the vertex coordinate points of a cut/separated mismatched pattern of interest.

In the verification region division A1, distances in the X-axis direction and the Y-axis direction of each vertex of a cut/separated mismatched pattern with reference to the vertex coordinate point D: (X_G2, Y_G2+W2) of the pattern G2 may be calculated, and the longer distance may be set as the distance of that vertex, and the smallest value of the calculated vertex distances may be set as a mismatch distance.

In the verification region division A3, distances in the X-axis direction and the Y-axis direction of each vertex of a cut/separated mismatched pattern with reference to the vertex coordinate point C: (X_G2+L2, Y_G2+W2) of the pattern G2 may be calculated, and the longer distance may be set as the distance of that vertex, and the smallest value of the calculated vertex distances may be set as a mismatch distance.

In the verification region division A7, distances in the X-axis direction and the Y-axis direction of each vertex of a cut/separated mismatched pattern with reference to the vertex coordinate point A: (X_G2, Y_G2) of the pattern G2 may be calculated, and the longer distance may be set as the distance of that vertex, and the smallest value of the calculated vertex distances may be set as a mismatch distance.

In the verification region division A5, a mismatch distance is set to 0 (zero) because the verification region division A5 overlaps the pattern G2. Note that, in the above example, it is assumed that a single cut/separated mismatched pattern is present in a verification region division, for the sake of simplicity. Even if a plurality of cut/separated mismatched patterns are present, the aforementioned mismatch distance calculation method is applicable to each mismatched pattern.

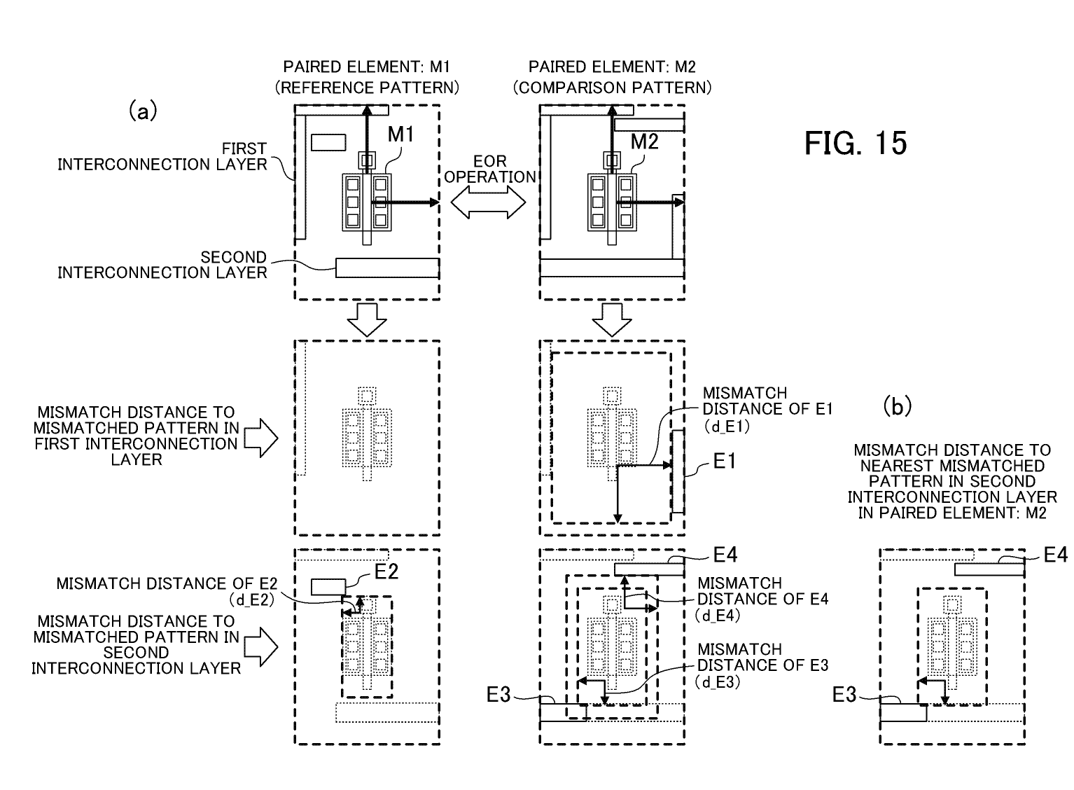

Here, a portion (a) of FIG. 15 shows the distance-to-mismatched pattern information 400 finally obtained. In the portion (a) of FIG. 15, the mismatched pattern E2 of the second interconnection layer is present in the verification region of the element M1, and a mismatch distance d_E2 between the transistor gate of the element M1 and the mismatched pattern E2 is obtained. Also, the mismatched pattern E1 of the first interconnection layer is present in the verification region of the element M2, and a mismatch distance d_E1 between the transistor gate of the element M2 and the mismatched pattern E1 is obtained. Also, the mismatched patterns E3 and E4 of the second interconnection layer are present in the verification region of the element M2, and mismatch distances d_E3 and d_E4 between the transistor gate of the element M2 and the mismatched patterns E3 and E4, respectively, are obtained.

In the above example, a mismatch distance is calculated for each cut/separated mismatched pattern. Alternatively, if there are a plurality of mismatched patterns in the same verification target layer (e.g., the cut/separated mismatched patterns E3 and E4 in a portion (b) of FIG. 15), the shortest distance (e.g., the distance to the mismatched pattern E3) may be set as a mismatch distance, whereby the calculation process can be simplified. These calculation methods may be previously flexibly switched, depending on settings of the mismatch distance calculation information 150.

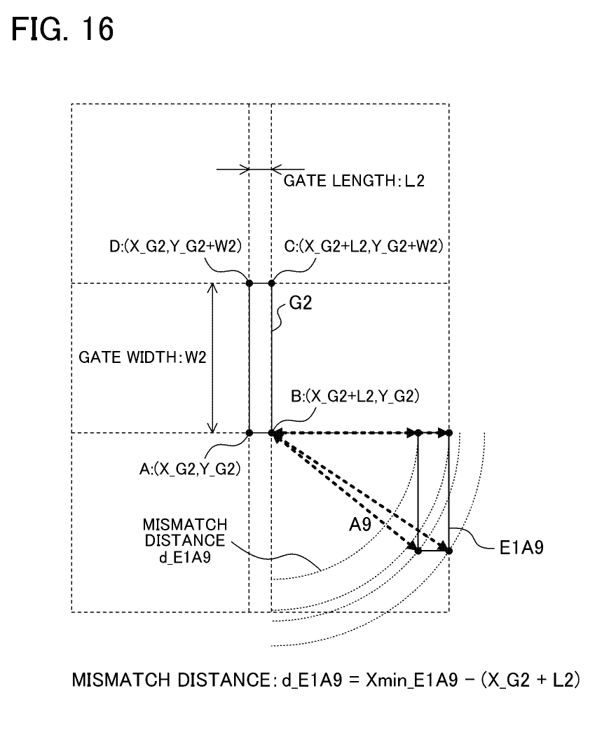

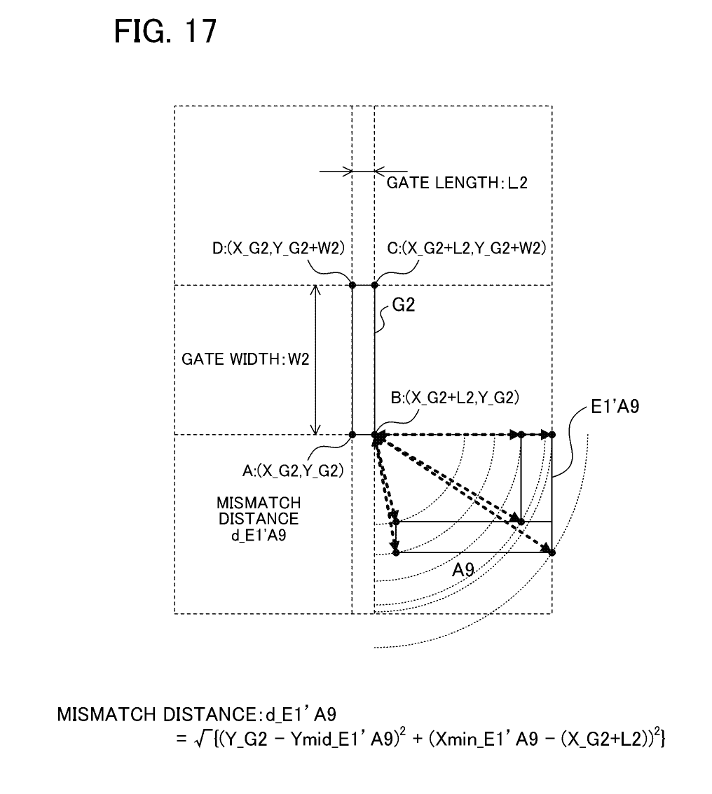

In the mismatch distance calculation method used in the verification region divisions A1, A3, A7, and A9, Manhattan distances in the X-axis direction and the Y-axis direction between a predetermined vertex of a verification element and vertices of a mismatched pattern on a layout pattern are calculated, the longer one of the X-axis direction distance and the Y-axis direction distance of each vertex of the mismatched pattern is set as the distance of that vertex, and the smallest value of the calculated vertex distances is set as a mismatch distance between the verification element and the mismatched pattern. Alternatively, for example, as shown in FIGS. 16 and 17, the straight line distance between a vertex B of a verification element and each vertex of a mismatched pattern may be calculated, and the smallest value of the calculated straight line distances of the vertices may be set as a mismatch distance. Note that, in a verification element, for example, the straight line distance between the edge G2_Edge1 and each edge of a mismatched pattern may be calculated, and the smallest value of the calculated straight line distances of the edges may be set as a mismatch distance. These methods may be previously flexibly switched, depending on settings of the mismatch distance calculation information 150. As a result, a mismatch distance can be easily calculated, and the calculation methods can be easily switched.

—Mismatch Area Calculating Step—

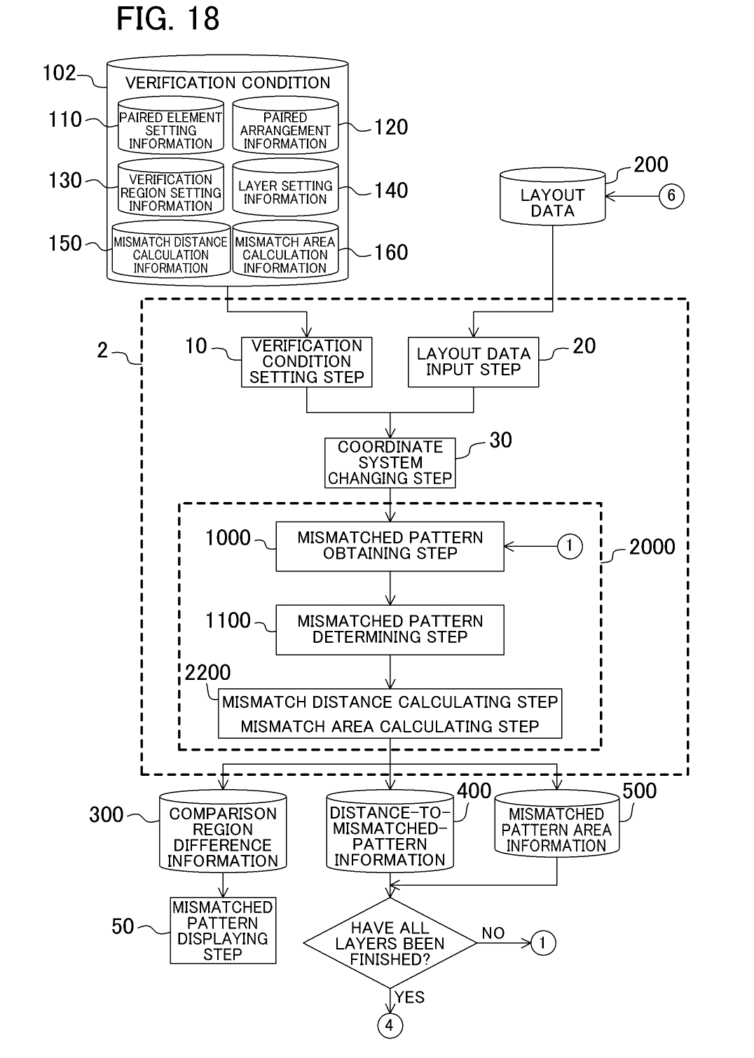

Next, a mismatch area calculating step 2210 in the verification flow of the layout verification step 2 will be described. Although a case where a mismatch distance between a verification element and a mismatched pattern is calculated has been described in the verification flow of FIG. 1, an area of the mismatched pattern as well as the mismatch distance is calculated in the verification flow of FIG. 18. The difference between the verification flows of FIG. 18 and FIG. 1 will be described. Firstly, the verification condition setting step 10 sets a verification condition 102 additionally including mismatch area calculation information 160 about settings for calculation of a mismatch area with respect to a mismatched pattern which is a result of pattern comparison. Thereafter, the mismatched pattern parameter calculation layout verification step 2000 calculates a distance between a verification element and a mismatched pattern, and also calculates an area of the mismatched pattern, to obtain the distance-to-mismatched pattern information 400 and mismatched pattern area information 500.

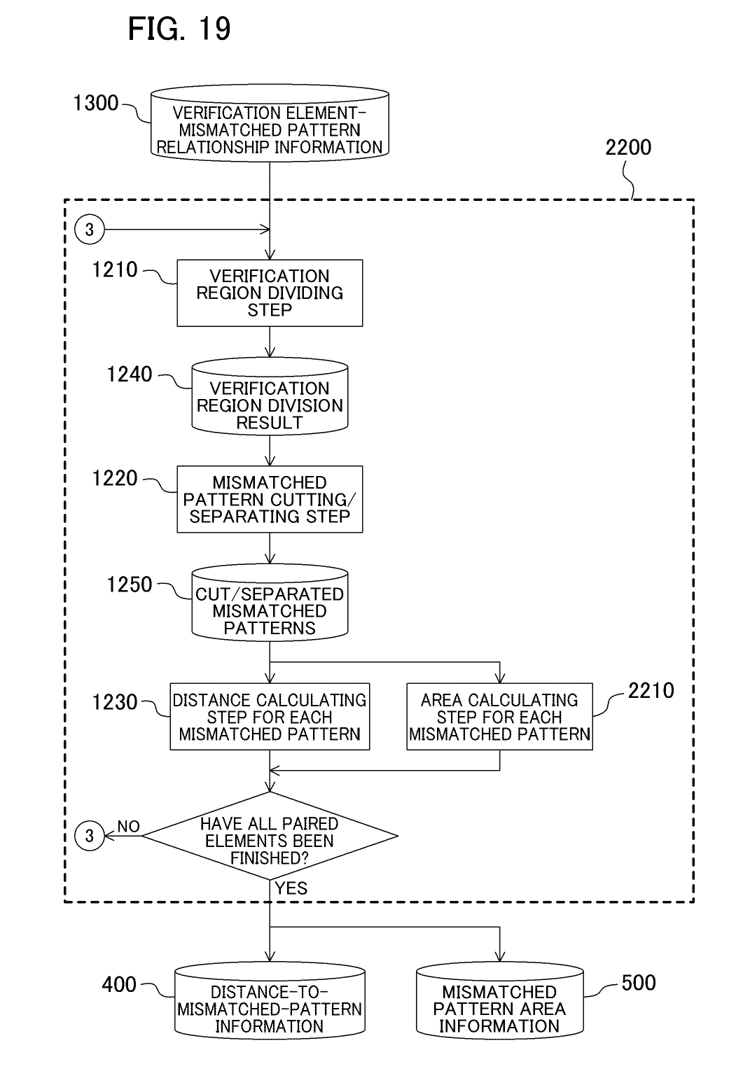

Also, FIG. 19 shows a process flow of a mismatch distance calculating step/mismatch area calculating step 2200, which is different from the process flow of FIG. 5 in the following point. The mismatch distance calculating step/mismatch area calculating step 2200 performs, based on the verification element-mismatched pattern relationship information 1300, an area calculating step 2210 (mismatch area calculating step) with respect to each cut/separated mismatched pattern 1250 obtained by the verification region dividing step 1210 and the mismatched pattern cutting/separating step 1220 to calculate the area of that cut/separated mismatched pattern 1250, and outputs the mismatched pattern area information 500.

—Area Determining Step—

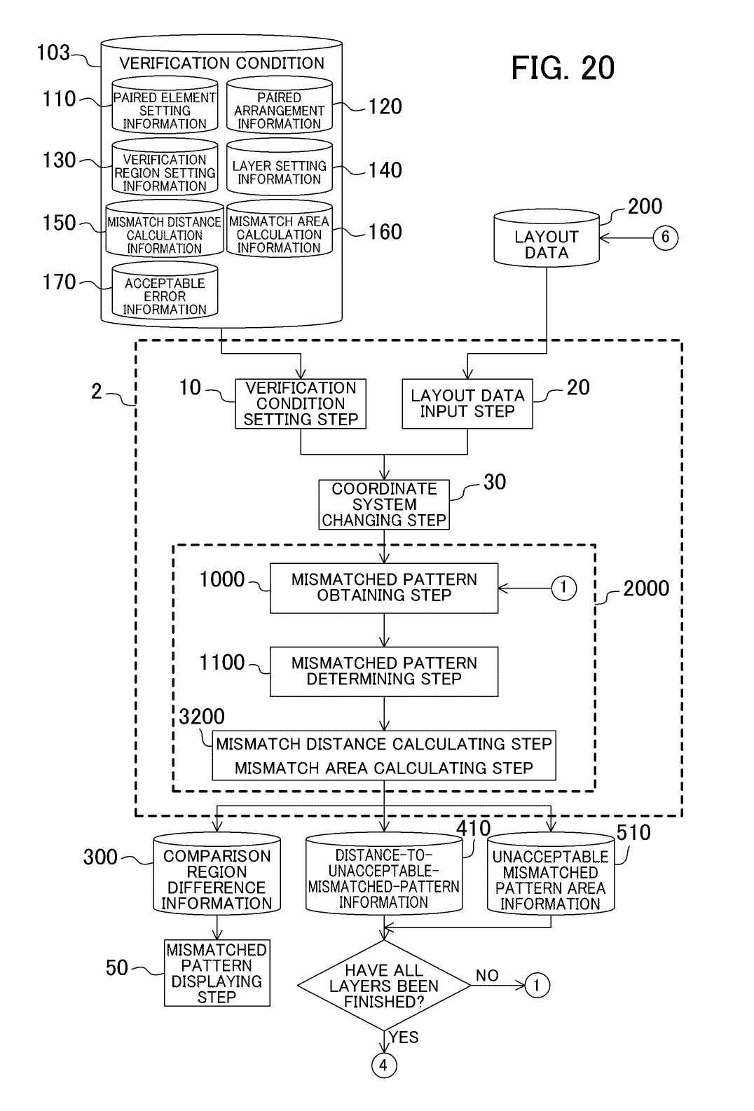

Next, an area determining step 3210 in the verification flow of the layout verification step 2 will be described. While, in FIG. 18, the area of a mismatched pattern is calculated in addition to a mismatch distance between a verification element and the mismatched pattern, an acceptable error based on the calculated mismatched pattern area is taken into consideration in FIG. 20. The difference between a verification flow shown in FIG. 20 and that already described in FIG. 18 will be described. Initially, the verification condition setting step 10 sets a verification condition 103 additionally including acceptable error information 170 for setting an acceptable value for the area of a mismatched pattern. The mismatched pattern parameter calculation layout verification step 2000 calculates the area of a mismatched pattern, and a distance between a verification element and the mismatched pattern, where the mismatched pattern is an unacceptable mismatched pattern 3220 which it has been determined that has an area larger than the desired acceptable value set in the acceptable error information 170, to obtain distance information 410 about the distance to the unacceptable mismatched pattern and area information 510 about the area of the unacceptable mismatched pattern.

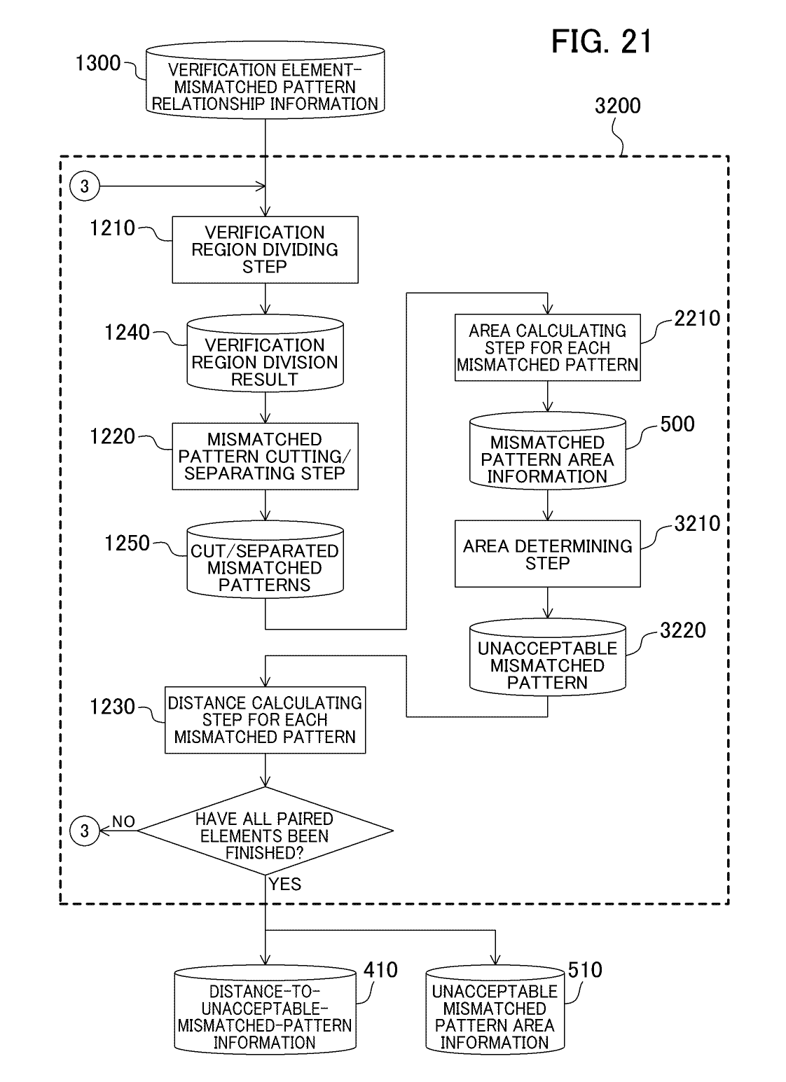

Also, FIG. 21 shows a process flow of a mismatch distance calculating step/mismatch area calculating step 3200, which is different from the process flow of FIG. 19 in the following point. The mismatch distance calculating step/mismatch area calculating step 3200 performs, based on the verification element-mismatched pattern relationship information 1300, a process described below with respect to each cut/separated mismatched pattern 1250 obtained by the verification region dividing step 1210 and the mismatched pattern cutting/separating step 1220.

Initially, the mismatched pattern area calculating step 2210 performs calculation based on each cut/separated mismatched pattern 1250 to obtain the mismatched pattern area information 500. Next, based on the mismatched pattern area information 500, the area determining step 3210 determines whether or not the area of a mismatched pattern is larger than the desired acceptable value set in the acceptable error information 170. When the mismatched pattern area is larger than the acceptable value, the unacceptable mismatched pattern 3220 is obtained. Next, the mismatched pattern distance calculating step 1230 performs calculation based on the unacceptable mismatched pattern 3220 to output the distance information 410 about the distance to the unacceptable mismatched pattern and the area information 510 about the area of the unacceptable mismatched pattern.

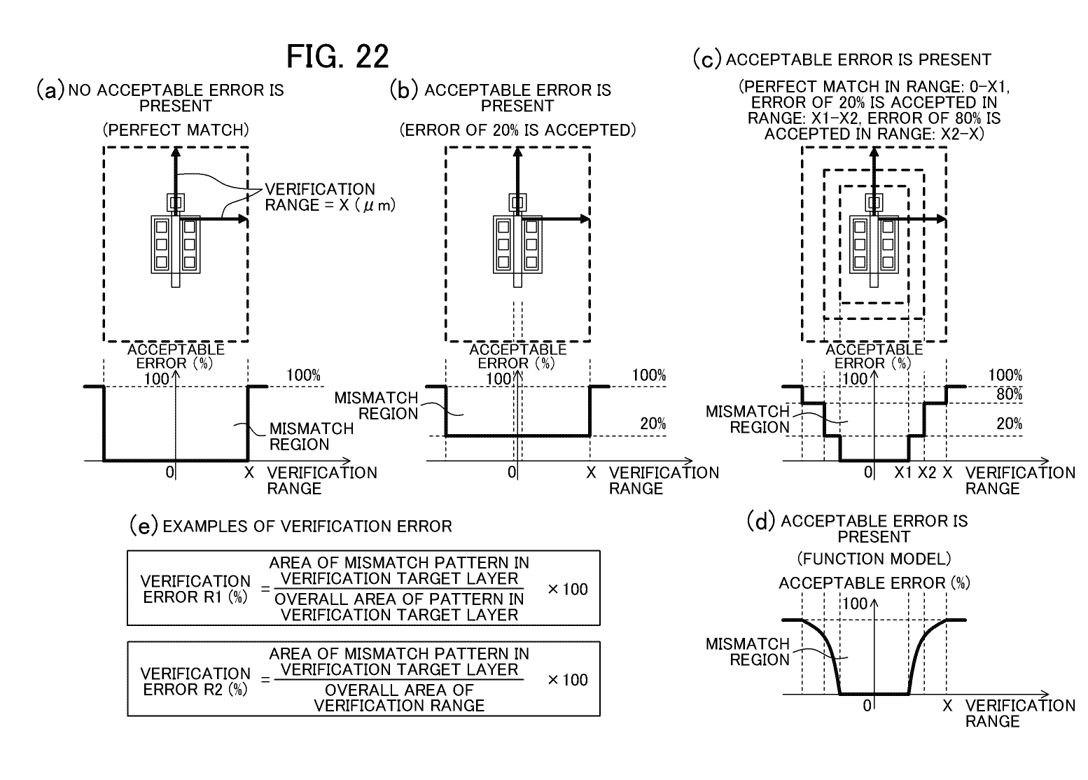

Here, an example of the acceptable error information 170 will be described with reference to FIG. 22. A portion (a) of FIG. 22 schematically shows a case where the acceptable value is zero, i.e., there is no acceptable error, indicating that there is a perfect match in the desired verification range=X (μm), i.e., a mismatched pattern obtained as a result of pattern comparison is not acceptable. In this case, the acceptable error information 170 indicates that the acceptable error (acceptable value)=0% in the verification range: 0-X (μm). A portion (b) of FIG. 22 schematically shows a case where there is an acceptable error, indicating that the acceptable error is uniformly 20% in the desired verification range=X (μm). In this case, the acceptable error information 170 indicates that the acceptable error=20% in the verification range: 0-X (μm). A portion (c) of FIG. 22 schematically shows another case where there is an acceptable error, indicating that the acceptable error is set in a stepwise manner in the desired verification range=X (μm). In this case, the acceptable error information 170 indicates that the acceptable error=0% in the verification range: 0-X1 (μm), the acceptable error=20% in the verification range: X1-X2 (μm), and the acceptable error=80% in the verification range: X2-X (μm). Note that, as another example where the acceptable error is varied and set, depending on the verification range, a desired function model, such as that shown in a portion (d) of FIG. 22, may be used. A portion (e) of FIG. 22 shows example calculations of a verification error. For example, a verification error R1 is defined as the ratio of the area of a mismatched pattern in a verification target layer to the overall pattern area in the verification target layer present in the desired verification range=X (μm). A verification error R2 is defined as the ratio of the area of a mismatched pattern in a verification target layer to the overall area of the desired verification range=X (μm). Note that when, as shown in the portion (c) of FIG. 22, the acceptable error is set in a stepwise manner, depending on the verification range, a verification error may be preferably defined as the ratio of the area of a mismatched pattern in a verification target layer to the area of each region in the verification range.

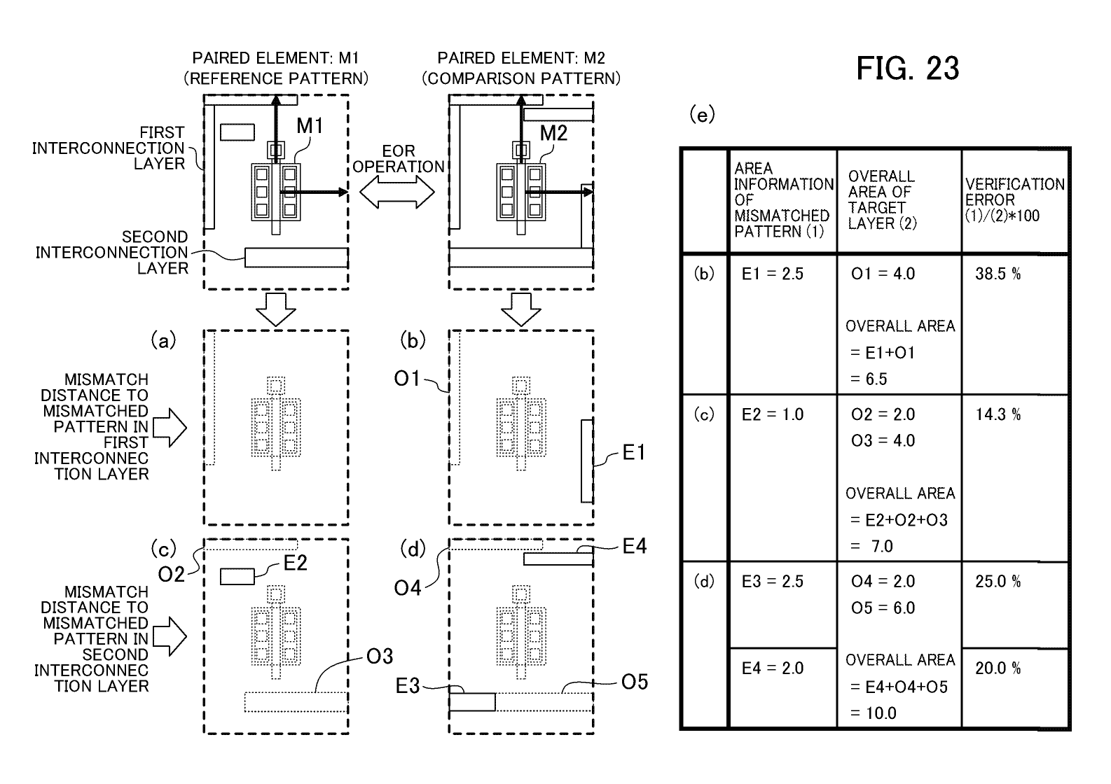

A specific example of the area determining step 3210 will be described with reference to FIG. 23. The area determining step 3210 performs determination based on the mismatched pattern area information 500 which has been obtained from the cut/separated mismatched patterns 1250 by the mismatched pattern area calculating step 2210 as shown in FIG. 21. Here, portions (a)-(d) of FIG. 23 show example of the cut/separated mismatched patterns 1250, and a portion (e) of FIG. 23 indicates an example of the mismatched pattern area information 500. For example, according to the portion (b) of FIG. 23 and the portion (e) of FIG. 23, the area of the mismatched pattern E1=2.5 (unit is not described), and the overall area of the target layer (here, the first interconnection layer of the element M2)=the area of E1+the area of O1=6.5. By calculation based on the definition of the verification error R1 shown in the portion (e) of FIG. 22, it is found that the mismatched pattern E1 has an error R1E1=2.5/6.5, i.e., about 38.5%.

By similar calculation, it is found that the mismatched pattern E2 has an error R1E2=14.3%, the mismatched pattern E3 has an error R1E3=25.0%, and the mismatched pattern E4 has an error R1E4=20.0%. On the other hand, for example, when it is assumed that the acceptable error is set to be less than or equal to 20.0% in the acceptable error information 170, the mismatched patterns E2 and E4 whose previously calculated errors match the acceptable error information 170 are acceptable, and only the mismatched patterns E1 and E3 are output as the unacceptable mismatched patterns 3220. Therefore, the mismatched pattern distance calculating step 1230 of FIG. 21 performs calculation based on only the mismatched patterns E1 and E3 as process targets.

—Characteristic Influence Calculating Step—

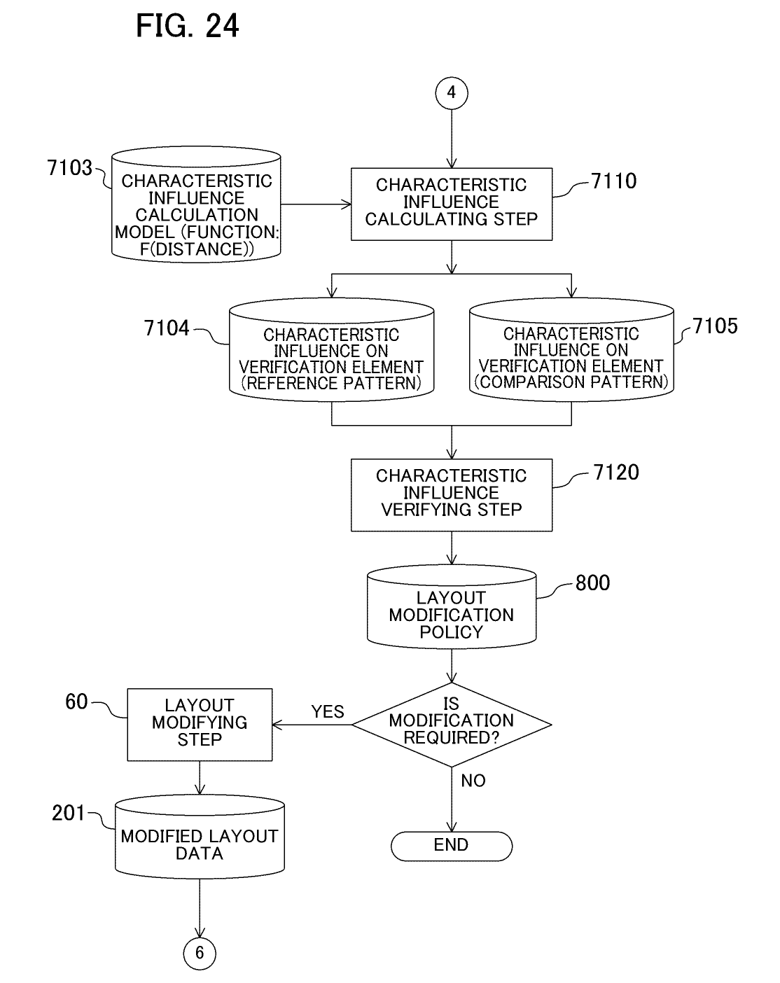

FIG. 24 shows a characteristic influence calculating step 7110. The characteristic influence calculating step 7110 performs calculation based on the information obtained in the aforementioned steps, and a characteristic influence calculation model 7103 which is previously prepared based on the process information, etc., to obtain the following characteristic influences of a mismatched pattern on a verification element: a characteristic influence 7104 of a reference pattern on the verification element; and a characteristic influence 7105 of a comparison pattern on the verification element.

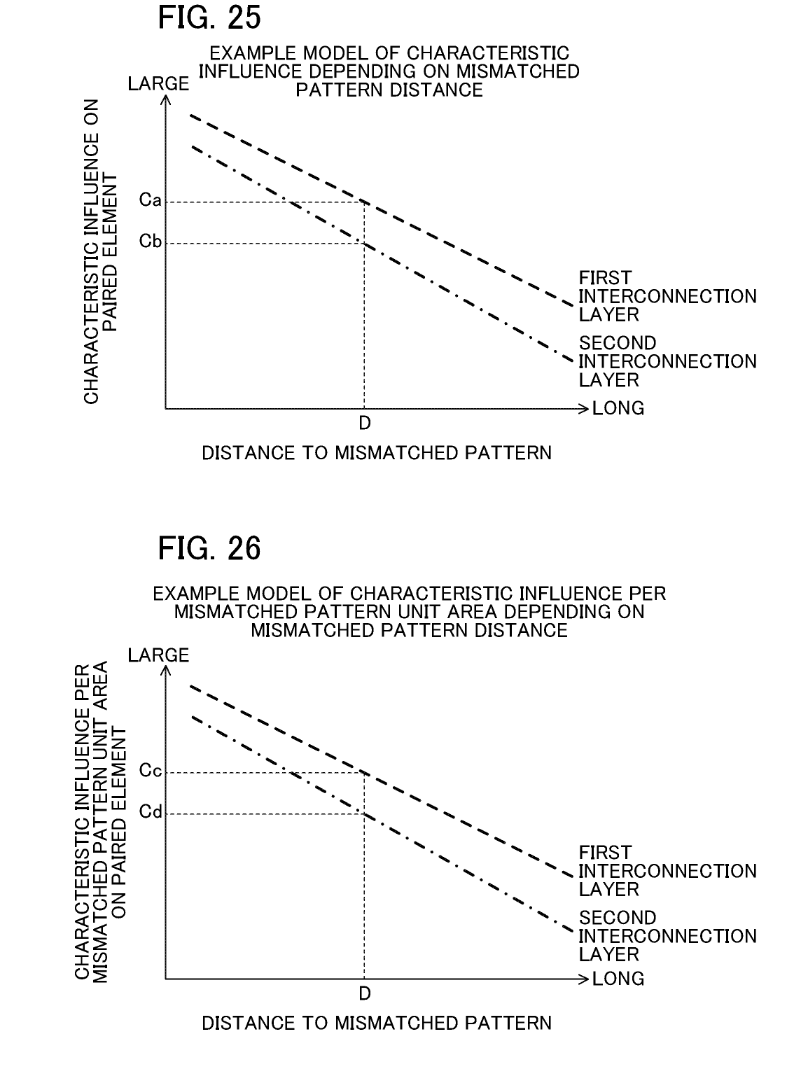

FIG. 25 shows an example of the characteristic influence calculation model 7103. FIG. 25 shows a characteristic influence depending on a distance to a mismatched pattern. The characteristic influence on a verification element decreases (increases) with an increase (decrease) in a distance to a mismatched pattern. The dependence is assumed to vary from verification target layer to verification target layer. For example, the characteristic influence=Ca where the distance to a mismatched pattern in the first interconnection layer=D, and the characteristic influence=Cb where the distance to a mismatched pattern in the second interconnection layer=D.

In FIG. 25, the characteristic influence calculating step 7110 calculates a characteristic influence depending on the distance to a mismatched pattern. Alternatively, the area of a mismatched pattern may be additionally taken into consideration. Specifically, for example, as shown in FIG. 26, a characteristic influence per mismatched pattern unit area depending on the distance to a mismatched pattern may be calculated. Also, the characteristic influence calculating step 7110 may calculate a characteristic influence for an unacceptable mismatched pattern. As a result, a characteristic influence per mismatched pattern unit area can be calculated, depending on information about the distance to a mismatched pattern, and a characteristic influence of a mismatched pattern on a verification element can be correctly calculated. Also, if a characteristic influence is calculated for an unacceptable mismatched pattern obtained in the area determining step 3210, the load of the process in the characteristic influence calculating step 7110 can be reduced.

In the above example, the characteristic influence calculating step 7110 calculates a characteristic influence from the distance-to-mismatched-pattern information or the area information. Alternatively, because the position of a mismatched pattern with respect to a verification element (a region where the mismatched pattern is provided) is known as described with reference to FIGS. 9 and 10, a characteristic influence on the verification element may be calculated using a characteristic influence model where, for example, a desired coefficient depending on the position is multiplied, in addition to the distance and area of the mismatched pattern.

—Characteristic Influence Verifying Step—

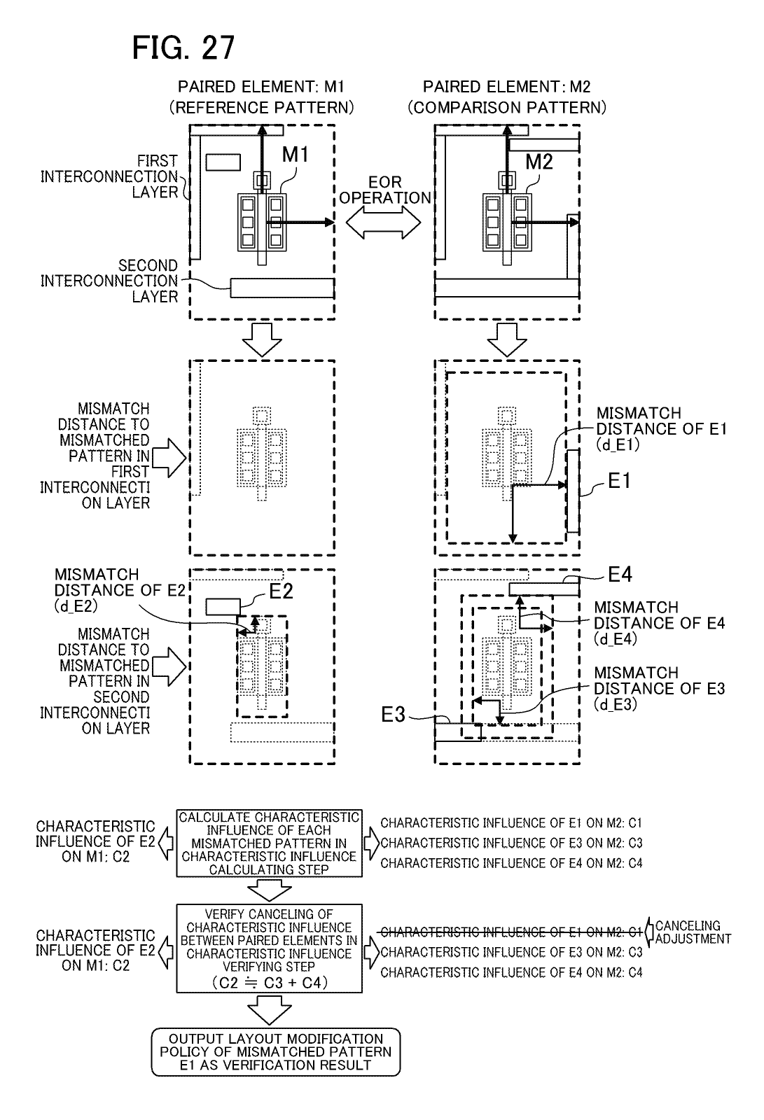

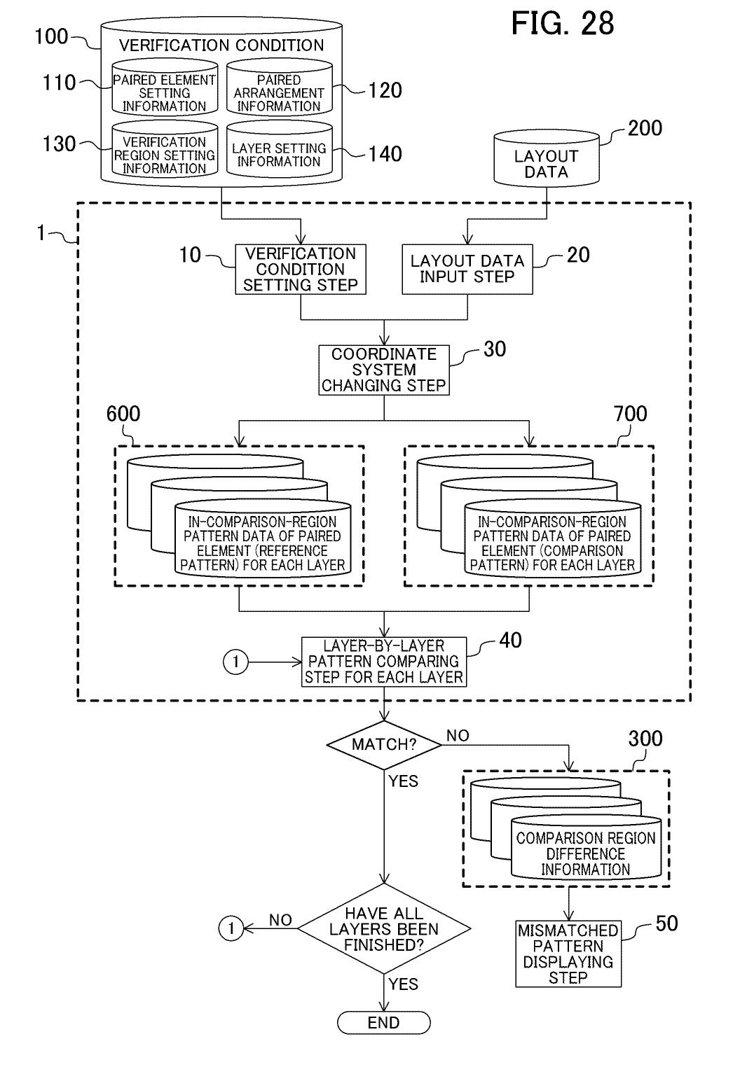

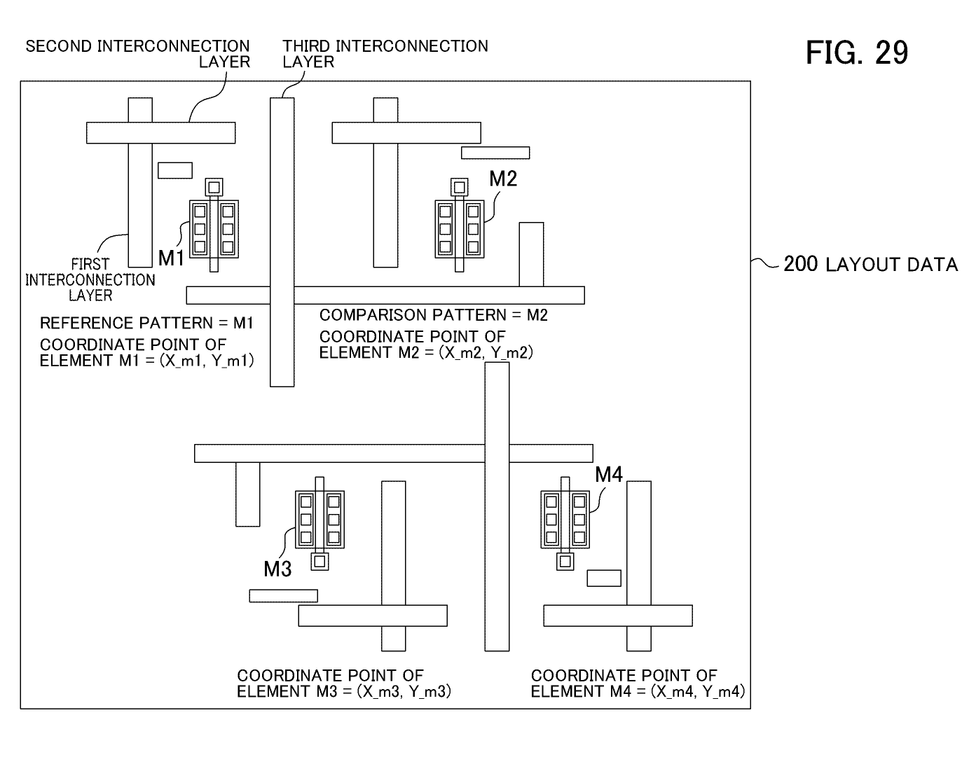

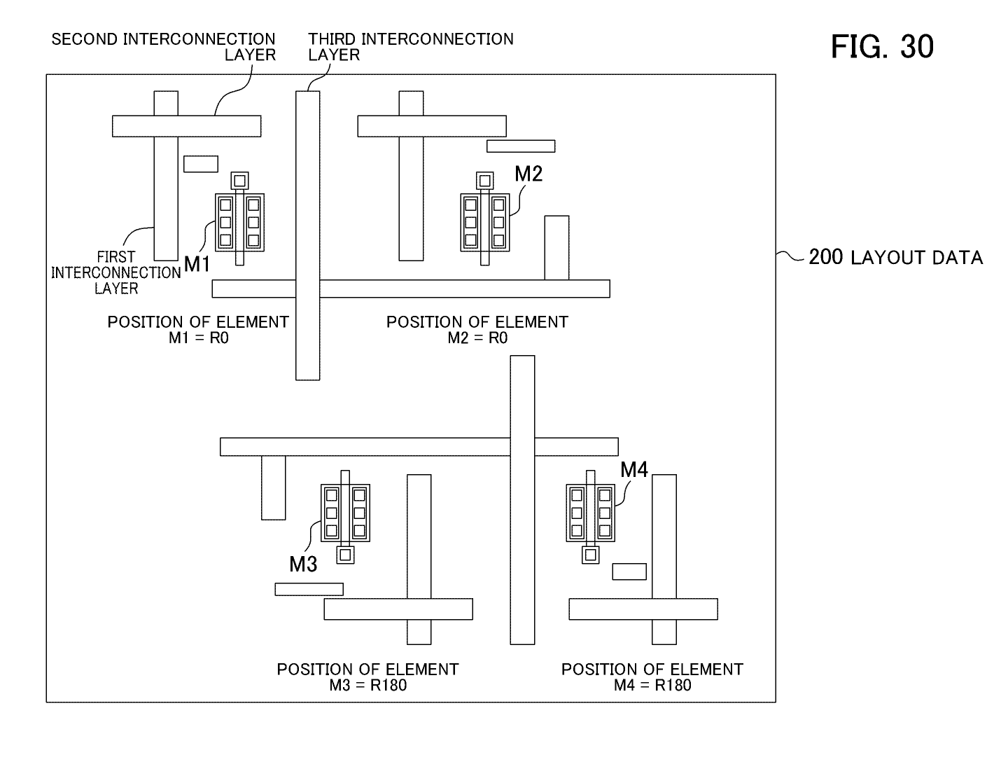

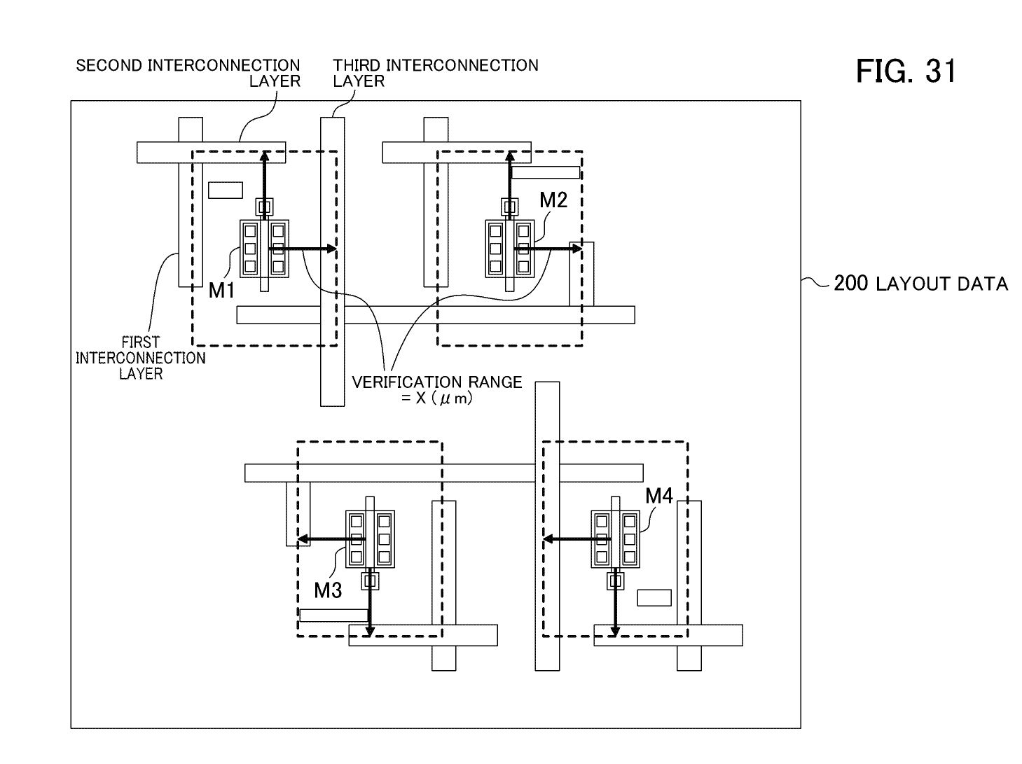

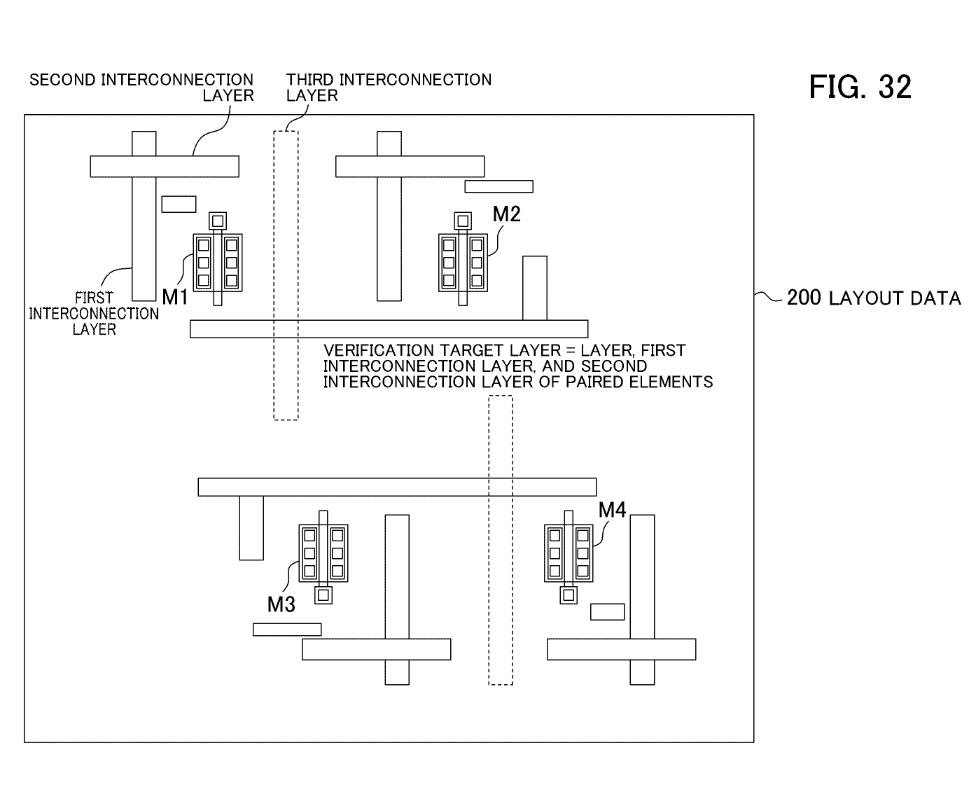

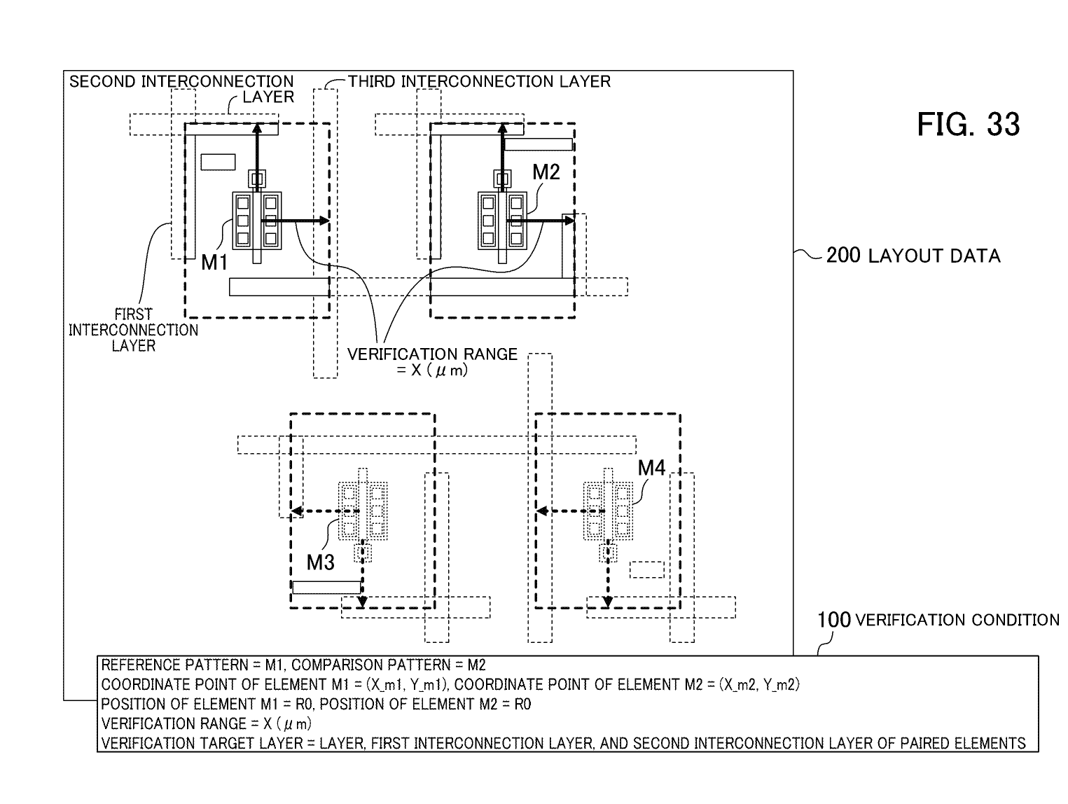

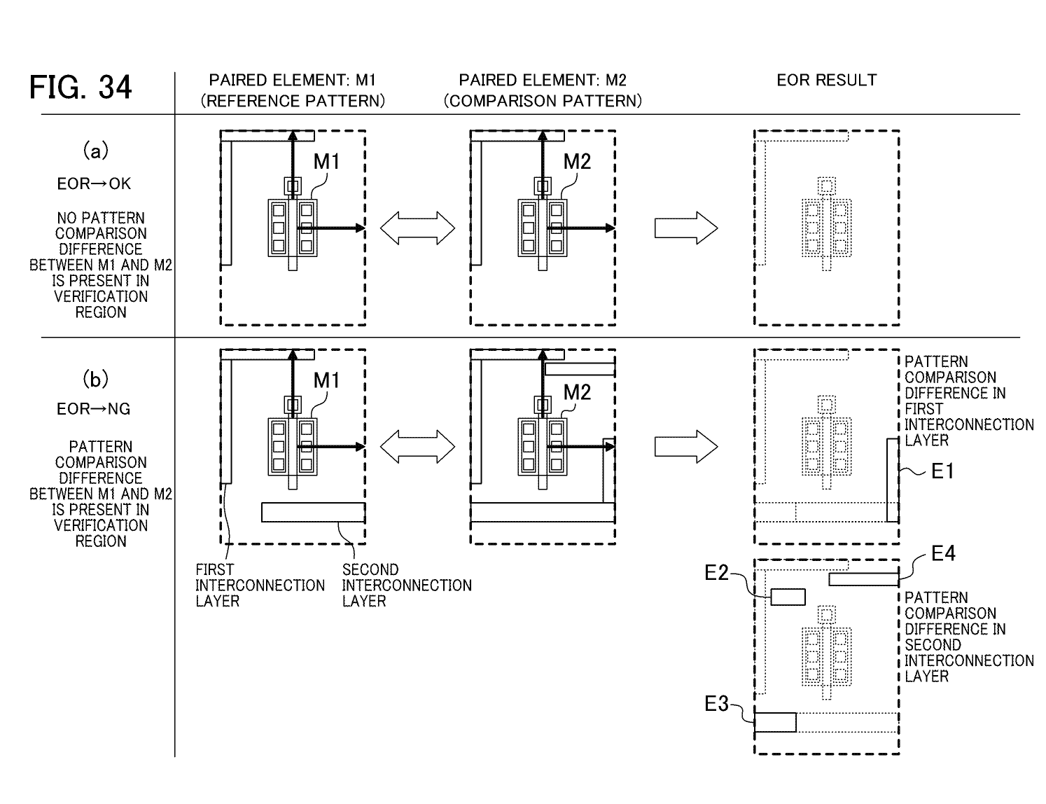

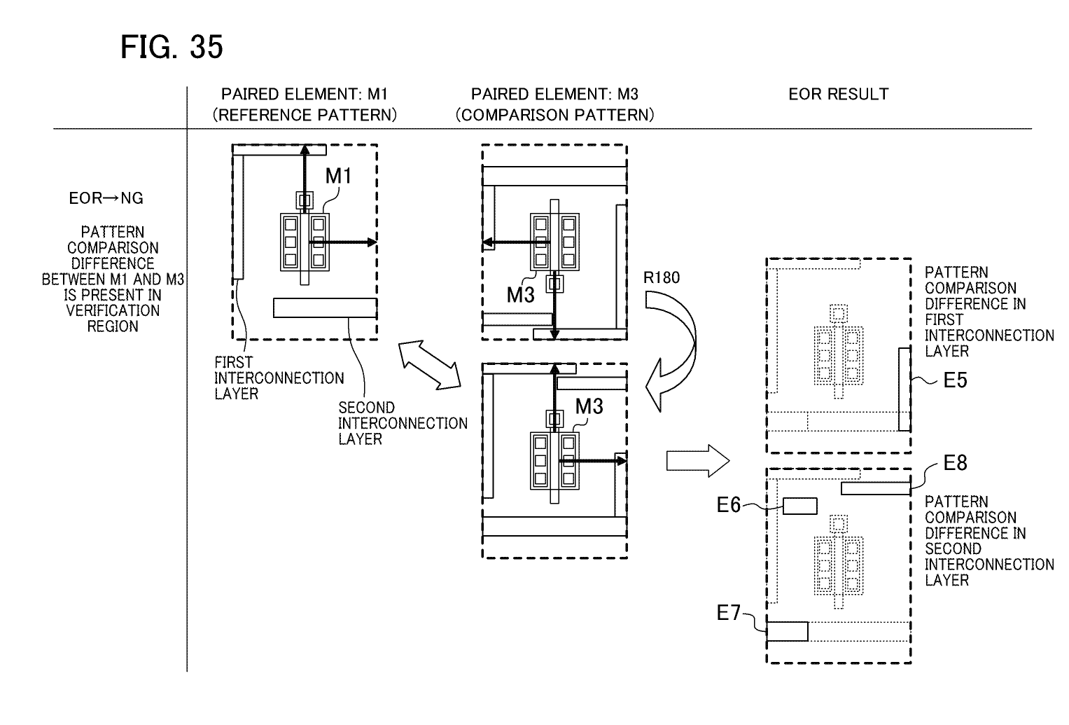

Referring back to FIG. 24, a characteristic influence verifying step 7120 performs verification based on the characteristic influence 7104 of a reference pattern on a verification element and the characteristic influence 7105 of a comparison pattern on a verification element, and outputs a layout modification policy 800. Here, an example of the characteristic influence verifying step 7120 will be briefly described with reference to FIG. 27. In FIG. 27, it is assumed that pattern comparison/verification has been finished, and therefore, the information d_E2 about the distance of the element M1 as a reference pattern to the mismatched pattern E2, and the information d_E1, d_E3, and d_E4 about the distances of the element M2 as a comparison pattern to the mismatched patterns E1, E3, and E4. From these pieces of the distance-to-mismatched pattern information and the characteristic influence calculation model 7103, the characteristic influence calculating step 7110 calculates a characteristic influence C2 of the mismatched pattern E2 on the element M1, a characteristic influence C1 of the mismatched pattern E1 on the element M2, a characteristic influence C3 of the mismatched pattern E3 on the element M2, and a characteristic influence C4 of the mismatched pattern E4 on the element M2. Thereafter, the characteristic influence verifying step 7120 verifies a plurality of combinations of the calculated characteristic influences on the elements M1 and M2 which cancel each other, to obtain a result, such as, for example, C2≈C3+C4. As a result, the layout modification policy 800 is obtained which indicates that layout modification is required for the mismatched pattern E1 which it has been found as a result of the verification that can be excluded from the characteristic influence canceling adjustment.

Alternatively, when the characteristic influence verifying step 7120 verifies combinations of the characteristic influence canceling adjustment, a desired canceling acceptable error may be previously set into the verification condition 103, and combinations in which characteristic influences cancel each other can be verified based on the canceling acceptable error.

The layout modification policy 800 preferably explicitly indicates not only a mismatched pattern for which layout modification is required, but also its basis, i.e., one or a plurality of combinations of characteristic influences which cancel each other, and also preferably explicitly and quantitatively indicates characteristic influences on a verification element for each combination.

Alternatively, the characteristic influence verifying step 7120 may perform a circuit simulating step in which the characteristic influence 7104 of a reference pattern on a verification element and the characteristic influence 7105 of a comparison pattern on the verification element are additionally taken into consideration, instead of the above verification process, whereby a characteristic influence can be estimated based on actual operation of the circuit.

—Layout Modifying Step—

Referring back to FIG. 24, a layout modifying step 60, if the layout modification policy 800 thus obtained indicates the necessity of layout modification, modifies the layout. Thereafter, the layout verification step 2 is repeated using the modified layout data 201. If layout modification is not required, the layout verification step 2 is ended.

As described above, according to the layout verification method, a characteristic influence of a mismatched pattern on a verification element can be obtained, depending on the mismatch distance. Also, by calculating the area of the mismatched pattern, the characteristic influence can be more correctly calculated. A characteristic influence may be calculated for an unacceptable mismatched pattern. When characteristic influences cancel each other, layout modification is not required. Therefore, the number of repetition of the layout modification step can be reduced.

What is claimed is:

1. A method for verifying a match between layout patterns of elements provided in a semiconductor integrated circuit, comprising:
a verification condition setting step of setting a verification condition including information about paired elements whose layout patterns should match each other;
a layout data input step of inputting layout data including pattern information and arrangement information of the paired elements; and
a mismatched pattern parameter calculation layout verifying step of comparing the layout patterns of the paired elements based on the verification condition and the layout data to calculate a distance between the paired elements and at least one mismatched pattern.

2. The method of claim 1, wherein
the mismatched pattern parameter calculation layout verifying step includes
a mismatched pattern obtaining step of verifying a match/mismatch between the layout patterns of the paired elements and between layout patterns of regions surrounding the paired elements based on the verification condition and the layout data,
a mismatched pattern determining step of determining which of the surrounding regions of the paired elements contains the at least one mismatched pattern between the layout patterns obtained in the mismatched pattern obtaining step, and
a mismatch distance calculating step of calculating a distance between the paired elements and the at least one mismatched pattern between the layout patterns obtained in the mismatched pattern obtaining step.

3. The method of claim 1, wherein
in the verification condition setting step, the verification condition for verifying a match between the layout patterns includes mismatch distance calculation information, and
the mismatched pattern parameter calculation layout verifying step sets, as a mismatch distance, a distance between the paired elements and the at least one mismatched pattern, where a shortest one of the longer ones of X-axis direction Manhattan distances and Y-axis direction Manhattan distances between vertices on a layout pattern of the paired elements and vertices on a layout pattern of the at least one mismatched pattern, is defined as the distance between the paired elements and the at least one mismatched pattern, based on the verification condition setting including the mismatch distance calculation information.

4. The method of claim 1, wherein
in the verification condition setting step, the verification condition for verifying a match between the layout patterns includes mismatch distance calculation information, and
the mismatched pattern parameter calculation layout verifying step sets, as a mismatch distance, a distance between the paired elements and the at least one mismatched pattern, where a straight-line and shortest one of distances between vertices or edges on a layout pattern of the paired elements and vertices or edges on a layout pattern of the at least one mismatched pattern, is defined as the distance between the paired elements and the at least one mismatched pattern, based on the verification condition setting including the mismatch distance calculation information.

5. The method of claim 1, wherein
in the verification condition setting step, the verification condition for verifying a match between the layout patterns includes mismatch distance calculation information, and
the mismatched pattern parameter calculation layout verifying step calculates a mismatch distance between the paired elements and each of the at least one mismatched pattern, based on the verification condition setting including the mismatch distance calculation information.

6. The method of claim 1, wherein
in the verification condition setting step, the verification condition for verifying a match between the layout patterns includes mismatch distance calculation information, and
the mismatched pattern parameter calculation layout verifying step calculates a shortest one of mismatch distances between the paired elements and a target one or ones of the at least one mismatched pattern, based on the verification condition setting including the mismatch distance calculation information.

7. The method of claim 1, further comprising:
a characteristic influence calculating step of calculating a characteristic influence on the paired elements based on a relationship between characteristic influences on elements and one of the mismatch distance calculated in the mismatched pattern parameter calculation layout verifying step, a mismatch area, and a position of the at least one mismatched pattern, or a combination thereof; and
a characteristic influence verifying step of verifying whether or not the calculated characteristic influence is acceptable for formation of the paired elements.

8. A method for verifying a match between layout patterns of elements provided in a semiconductor integrated circuit, comprising:
a verification condition setting step of setting a verification condition including information about paired elements whose layout patterns should match each other;
a layout data input step of inputting layout data including pattern information and arrangement information of the paired elements; and
a mismatched pattern parameter calculation layout verifying step of comparing the layout patterns of the paired elements based on the verification condition and the layout data to calculate a distance between the paired elements and at least one mismatched pattern, and an area of the at least one mismatched pattern.

9. The method of claim 8, wherein
the mismatched pattern parameter calculation layout verifying step includes
a mismatched pattern obtaining step of verifying a match/mismatch between the layout patterns of the paired elements and between layout patterns of regions surrounding the paired elements based on the verification condition and the layout data,
a mismatched pattern determining step of determining which of the surrounding regions of the paired elements contains the at least one mismatched pattern between the layout patterns obtained in the mismatched pattern obtaining step,
a mismatch distance calculating step of calculating a distance between the paired elements and the at least one mismatched pattern between the layout patterns obtained in the mismatched pattern obtaining step, and
a mismatch area calculating step of calculating an area of the at least one mismatched pattern between the layout patterns obtained in the mismatched pattern obtaining step.

10. The method of claim 8, wherein
in the verification condition setting step, the verification condition for verifying a match between the layout patterns includes mismatch distance calculation information, and
the mismatched pattern parameter calculation layout verifying step sets, as a mismatch distance, a distance between the paired elements and the at least one mismatched pattern, where a shortest one of the longer ones of X-axis direction Manhattan distances and Y-axis direction Manhattan distances between vertices on a layout pattern of the paired elements and vertices on a layout pattern of the at least one mismatched pattern, is defined as the distance between the paired elements and the at least one mismatched pattern, based on the verification condition setting including the mismatch distance calculation information.

11. The method of claim 8, wherein
in the verification condition setting step, the verification condition for verifying a match between the layout patterns includes mismatch distance calculation information, and
the mismatched pattern parameter calculation layout verifying step sets, as a mismatch distance, a distance between the paired elements and the at least one mismatched pattern, where a straight-line and shortest one of distances between vertices or edges on a layout pattern of the paired elements and vertices or edges on a layout pattern of the at least one mismatched pattern, is defined as the distance between the paired elements and the at least one mismatched pattern, based on the verification condition setting including the mismatch distance calculation information.

12. The method of claim 8, wherein
in the verification condition setting step, the verification condition for verifying a match between the layout patterns includes mismatch distance calculation information, and
the mismatched pattern parameter calculation layout verifying step calculates a mismatch distance between the paired elements and each of the at least one mismatched pattern, based on the verification condition setting including the mismatch distance calculation information.

13. The method of claim 8, wherein
in the verification condition setting step, the verification condition for verifying a match between the layout patterns includes mismatch distance calculation information, and
the mismatched pattern parameter calculation layout verifying step calculates a shortest one of mismatch distances between the paired elements and a target one or ones of the at least one mismatched patterns, based on the verification condition setting including the mismatch distance calculation information.

14. The method of claim 8, wherein
in the verification condition setting step, the verification condition for verifying a match between the layout patterns includes mismatch distance calculation information and mismatch area calculation information, and
the mismatched pattern parameter calculation layout verifying step calculates a distance between the paired elements and the at least one mismatched pattern, and an area of the at least one mismatched pattern, based on the verification condition setting including the mismatch distance calculation information and the mismatch area calculation information.

15. The method of claim 8, wherein
in the verification condition setting step, the verification condition for verifying a match between the layout patterns includes mismatch distance calculation information, mismatch area calculation information, and verification acceptable error information, and
the mismatched pattern parameter calculation layout verifying step verifies a perfect match or a match within an acceptable range between the layout patterns of the paired elements and between layout patterns of regions surrounding the paired elements, and calculates a distance between the paired elements and the at least one mismatched pattern, and an area of the at least one mismatched pattern, based on the verification condition setting including the mismatch distance calculation information, the mismatch area calculation information, and the verification acceptable error information.

16. The method of claim 8, further comprising:
a characteristic influence calculating step of calculating a characteristic influence on the paired elements based on a relationship between characteristic influences on elements and one of the mismatch distance and the mismatch area calculated in the mismatched pattern parameter calculation layout verifying step, and a position of the at least one mismatched pattern, or a combination thereof; and
a characteristic influence verifying step of verifying whether or not the calculated characteristic influence is acceptable for formation of the paired elements.
